(19) United States
(12) Patent Application Publication
(10) Pub. No.: US 2026/0148060 A1
(43) Pub. Date: May 28, 2026

(54) NEURAL NETWORK MODEL FOR SEQUENCE PREDICTION WITH ATTENTION TO ENTITY RELATIONSHIPS

(71) Applicant: Microsoft Technology Licensing, LLC, Redmond, WA (US)

(72) Inventors: Mohammad H. Firooz, Los Altos, CA (US); Maziar Sanjabi Boroujeni, San Francisco, CA (US); Adrian Englhardt, Dublin (IE); Tao Song, Santa Clara, CA (US); Qingquan Song, Sunnyvale, CA (US); Aman Gupta, San Jose, CA (US); Gungor Polatkan, San Jose, CA (US); Souvik Ghosh, Saratoga, CA (US); Dawn Banister Woodard, Redwood City, CA (US); Luke E. Simon, Emerald Hills, CA (US); Necip Fazil Ayan, Menlo Park, CA (US)

(21) Appl. No.: 18/963,453

(22) Filed: Nov. 27, 2024

(51) Int. Cl. G06N 3/08

(52) U.S. Cl. CPC G06N 3/08; G06F 40/284

(57) ABSTRACT

An example formulates a training input for a neural network model with attention to include action data and descriptive content. The action data includes a first entity identifier (ID) and a first sequence of actions associated with the first entity ID. The descriptive content describes a first entity associated with the first entity ID. An action in the first sequence of actions includes an electronic transmission involving the first entity and a second entity. An example uses the training input, including the first entity ID, and a non-standardized tokenizer, to train the neural network model with attention to generate and output a second sequence of actions.

### TECHNICAL FIELD

A technical field to which this disclosure relates includes artificial neural networks. Another technical field to which this disclosure relates includes the construction and application of neural networks with attention for sequence prediction, including multi-task sequence prediction. Other technical fields to which this disclosure may relate include recommendation systems, search engines, conversational question-and-answer systems, fraud detection systems, robotic systems, vehicle systems, and/or network security.

### COPYRIGHT NOTICE

This patent document, including the accompanying drawings, contains material that is subject to copyright protection. The copyright owner has no objection to the facsimile reproduction of this patent document, as it appears in the publicly accessible records of the United States Patent and Trademark Office, consistent with the fair use principles of the United States copyright laws, but otherwise reserves all copyright rights whatsoever.

### BACKGROUND

In computer science, an artificial neural network, or simply neural network, includes functional units connected by edges, with groups of units arranged into layers. Units receive input signals from connected units, process the input signals using activation functions, and provide output signals to other connected units. The output of each unit is computed by the activation function. The connections between the units apply weight values to the signals. These weight values are adjusted through a training process. In some examples, different layers of the neural network perform different transformations on the respective inputs and pass output of the respective transformations to other layers.

Matching systems are computer systems that generate predictive output indicating the extent to which digital items match each other according to one or more matching criteria. Ranking systems rank the digital items in accordance with one or more ranking criteria, which may be different from the matching criteria.

### BRIEF DESCRIPTION OF THE DRAWINGS

The disclosure will be understood more fully from the detailed description given below and from the accompanying drawings of various examples of the disclosure. The drawings are for explanation and understanding only and should not be taken to limit the disclosure to the specific examples shown.

FIG. 1 is a component-based flow diagram of an example method for training a neural network to predict an action sequence in accordance with some examples of the present disclosure.

FIG. 2 is an example of an entity graph in accordance with some embodiments of the present disclosure.

FIG. 3 is a component-based flow diagram of an example method for predicting an action sequence using a neural network in accordance with some examples of the present disclosure.

FIG. 4 is a table showing examples of input and output of a neural network in accordance with some examples of the present disclosure.

FIG. 5 is a block diagram of an example neural network in accordance with some examples of the present disclosure.

FIG. 6 is a block diagram of an example neural network in accordance with some examples of the present disclosure.

FIG. 7 is a component-based flow diagram of an example method for serving a neural network model in accordance with some examples of the present disclosure.

FIG. 8 is a flow diagrams of an example method for action sequence prediction using a neural network in accordance with some examples of the present disclosure.

FIG. 9 is a block diagram of a computing system that includes a sequence prediction system in accordance with some examples of the present disclosure.

FIG. 10 is a block diagram of an example computer system including components of a sequence prediction system in accordance with some examples of the present disclosure.

### DETAILED DESCRIPTION

Some neural network architectures perform well for simple matching tasks, such as matching tasks that involve entities that do not have relationships with other entities. Bi-encoder or multi-tower model architectures have been used for embedding generation but are inherently low rank, low capacity models that do not have sufficient model complexity to reliably capture cross-entity relationships. Multi-stage ranking models perform matching and ranking in two independent steps. These models have proven to be unscalable, time-consuming to maintain, and ineffective at handling more complex matching scenarios.

Some large language models (LLMs) support zero-shot and few-shot querying. However, fine-tuning these models for domain-specific tasks is computationally resource-intensive and requires engineers to spend considerable time on model selection, training strategy, and deployment. LLMs are commonly trained on natural language textual content and struggle when the model input contains structured data such as entity references mixed in with the natural language content.

Additionally, LLMs are commonly trained on large data sets (e.g., millions or billions of pieces of content) that are generalized and not entity-specific. As a result, while these LLMs may be capable of providing output across a wide range of tasks and domains, it is a technical challenge to cause LLMs to generate entity-specific predictions (e.g., to limit the portions of the model's training data that are used to generate the predictive output).

Further, when the input to the LLM is longer in length (e.g., closer to the maximum context length of the LLM), the attention mechanisms of some LLMs tend to weight the beginning and ending portions of the input more highly than the middle portions of the input, irrespective of the contents of those middle portions. As a result, the predictive performance of some LLMs degrades when the models underweight salient information contained in the middle portions of the input, such as information about relationships between entities.

Examples described herein aim to mitigate these and/or other technical challenges. Examples provide training approaches and architectural extensions that enable large language models and other deep neural networks with attention mechanisms (such as other forms of transformer models, recurrent neural networks with attention, convolutional neural networks with attention, etc.) to effectively machine-learn cross-entity relationships from inputs of any length up to the maximum length permitted by the model, including inputs that contain combinations of descriptive content, historical action sequences, and/or graph connections as context for a request.

Examples are designed to improve the ability of neural network models with attention to identify cross-entity relationships in long inputs (e.g., inputs that include a lengthy action sequence in the request or context) such that, after training using the described techniques, the neural network models with attention are capable of generating improved predictive output irrespective of the length of the action sequences. Neural network models with attention trained using the described techniques are capable of generating improved predictive outputs at scale and across multiple different tasks. Such neural network models are usable as foundation models that can support multiple different matching tasks either by themselves or through distillation into smaller models.

As described in more detail below, examples include a tokenizer extension or non-standardized tokenizer that facilitates the model's ability to machine-learn cross-entity relationships from training input that includes a mixture of natural language or textual content and entity references. Examples provide entity-specific mapping tables that enable the integration of entity-specific embeddings when corresponding entity identifiers are encountered in the model input.

Examples configure the model input and/or model parameters so that attention mechanisms of the model weight the temporal order of different portions of the model input relative to each other (e.g., temporal or relative position) more highly than their respective positions relative to the beginning and end of the model input (e.g., spatial or absolute position). That is, given first and second portions of a model input, the attention mechanisms prioritize the order in which the first and second portions of the model input occur relative to each other (temporal or relative position) more highly than the positions of those portions relative to the entire length of the model input (spatial or absolute position). For instance, whether the first portion occurs before the second portion or the second portion occurs before the first portion is weighted more highly than whether the first and second portions are respectively located at the beginning, in the middle, or at the end of the model input as a whole.

Examples provide training methods and/or model extensions that enable entity-specific information (e.g., information associated with a unique entity identifier (ID), such as entity-specific profile information, interaction data, etc.) to be included in the training data and the relationships between the entity-specific information and the corresponding entity ID are retained in the model through the training process. For instance, if a particular application has one billion identified entities and a model has five hundred billion total parameters, then, using the described techniques, for a given entity, five hundred of the model's parameters may be allocated to retaining entity-specific information for that specific entity only.

In other words, the described techniques result in a trained model that contains an entity-specific set of one or more parameters for each entity identified by a unique entity identifier (ID) in the training data. As a result, in response to a model input that includes one or more entity IDs, examples of the trained model use the entity-specific model parameters associated with the respective entity IDs identified in the model input to generate corresponding predictive output that includes the entity-specific training data associated with those entity IDs. As a result, the described training methods are capable of producing trained models that can handle queries that contain entity IDs and generate responses to those queries that contain information that is specific to those entity IDs contained in the queries. Thus, the described approaches provide a neural network with attention that is capable of recognizing entity-specific descriptions and this capability allows for the model to extract entity-specific instances for personalization of responses.

Other modeling approaches require matching and ranking to be performed by multiple different models. Examples described provide training methods and/or model extensions that enable a single model to be used for both entity matching and ranking.

These and/or other aspects of the described examples reduce the need for subsequent fine-tuning and thereby reduce the burden on computational resources.

Examples of entities include users, digital content items, such as posts, feed items, notifications, job postings, profiles, etc., other types of entities, such as companies, organizations, institutions, associations, cohorts, or groups of entities, and/or to potential sources of signals such as devices, networks, systems, components, processes, models, or agents.

Examples of actions include user interactions with application software systems and/or other types of electronic transmissions, such as inter-process communications, application programming interface (API) calls, messaging communications, notifications, network communications, signal transmissions from sensing devices, etc.

In some examples, model input includes a request, such as a query, instruction, or LLM prompt, and context. Examples of context include data associated with entity identifiers, such as associated entity profiles, graph connections, and/or interaction logs. Some examples of context include signals from an environment (e.g., sensor signals), network (e.g., communications from servers or devices, etc.), or device, such as signals logged during the same login session and/or previous login sessions (e.g., clicks, taps, views, likes, follows, scrolls, etc.). Some examples of context include digital content created, shared, or reacted-to by a user associated with an entity identifier, such as articles, posts, videos, images, graphics, comments, and reactions (e.g., likes, etc.).

The ability to predict a subsequent action sequence from a previous action sequence can be beneficial to many different types of tasks. Examples of tasks for which action sequence predictions are usable include hardware-centric and/or software-centric tasks. An example of a task that relates to network security is detecting and resolving a denial of service attack on a communication network. An example of a task that relates to devices for managing network traffic is load balancing. An example of a task that relates to control systems is the control of a physical device such as a sensing device, robot or vehicle. An example of a task that relates to application security or access control is detecting and disabling fraudulent accounts within an application system. An example of a task that relates to content distribution systems is controlling the distribution of digital content across user accounts on a network or device. An example of a task that relates to ease of use of a computer or other device is controlling the number of interactions between a user and the computer or other device.

The disclosure will be understood more fully from the detailed description given below, which references the accompanying drawings. The detailed description of the drawings is for explanation and understanding, and should not be taken to limit the disclosure to the specific examples described.

In the drawings and the following description, components shown and described in connection with an example are usable with or incorporated into other examples. In some examples, a component illustrated in a certain drawing is not limited to use in connection with an example to which the drawing pertains, but is usable with or incorporated into other examples, including examples shown in other drawings.

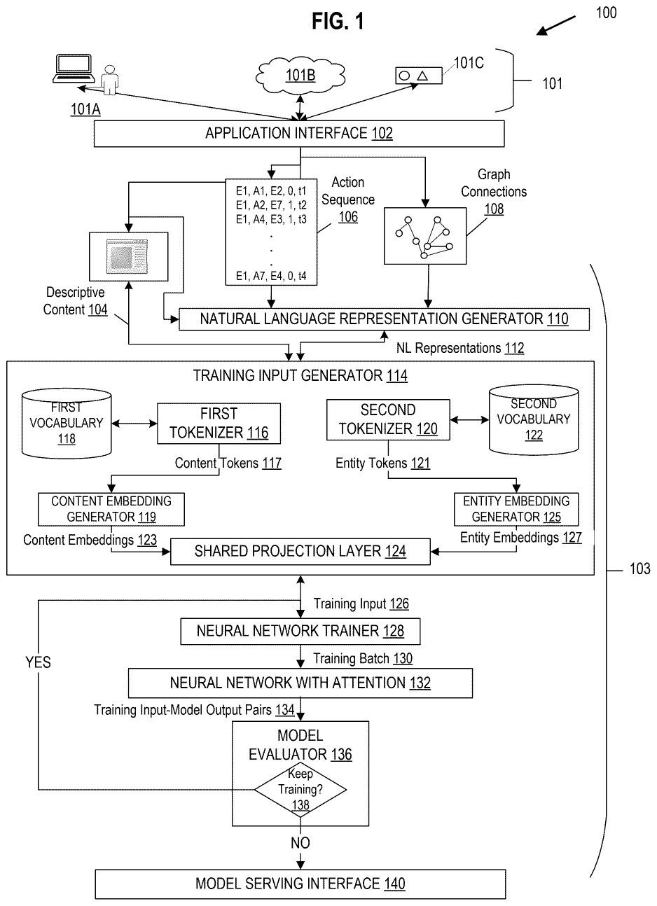

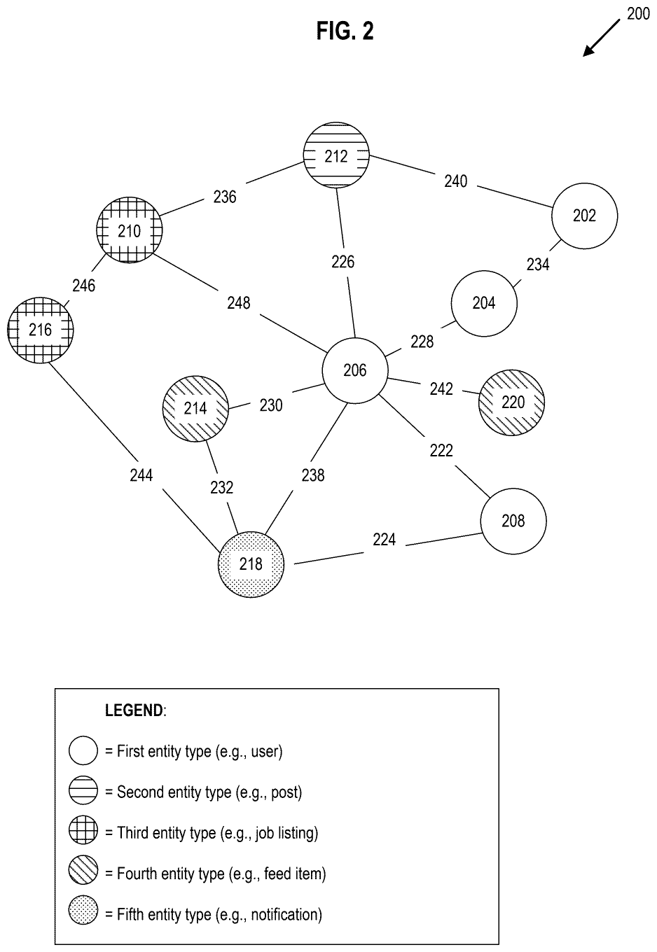

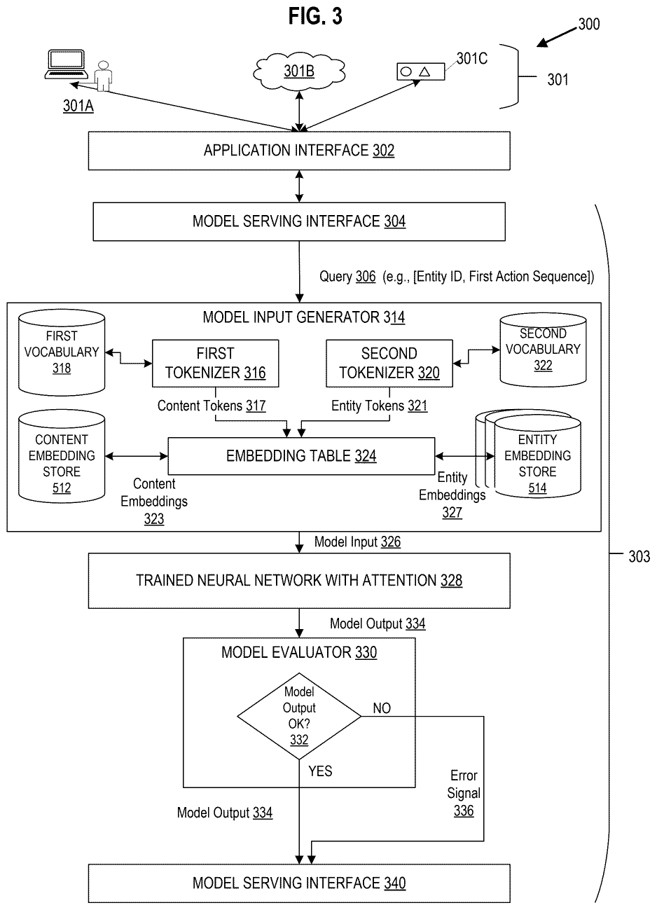

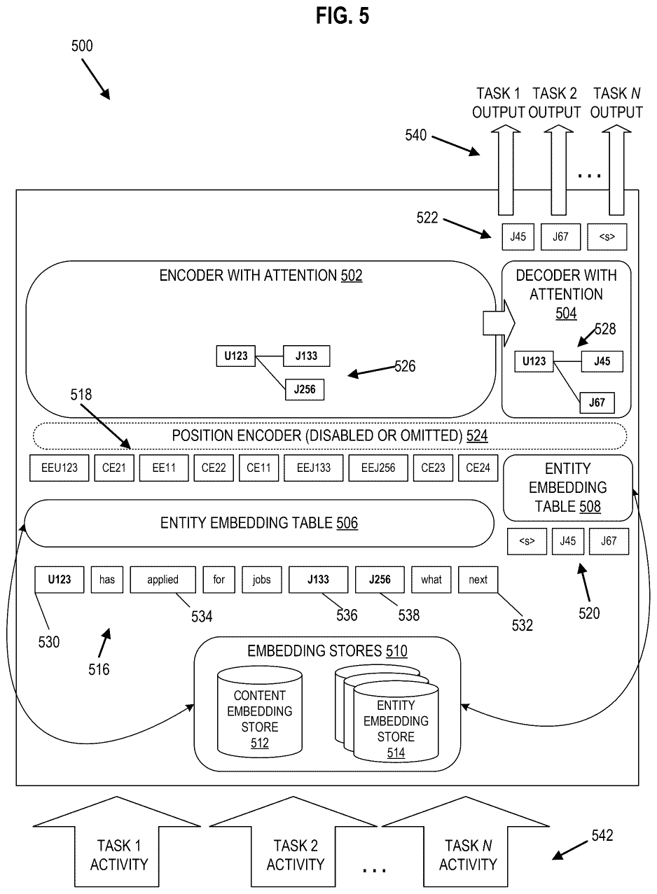

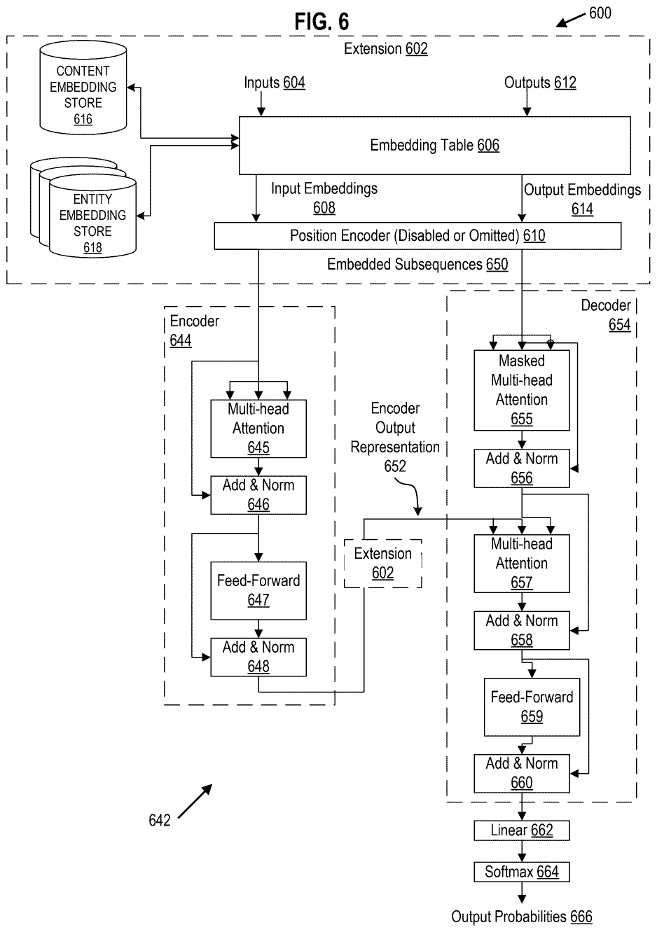

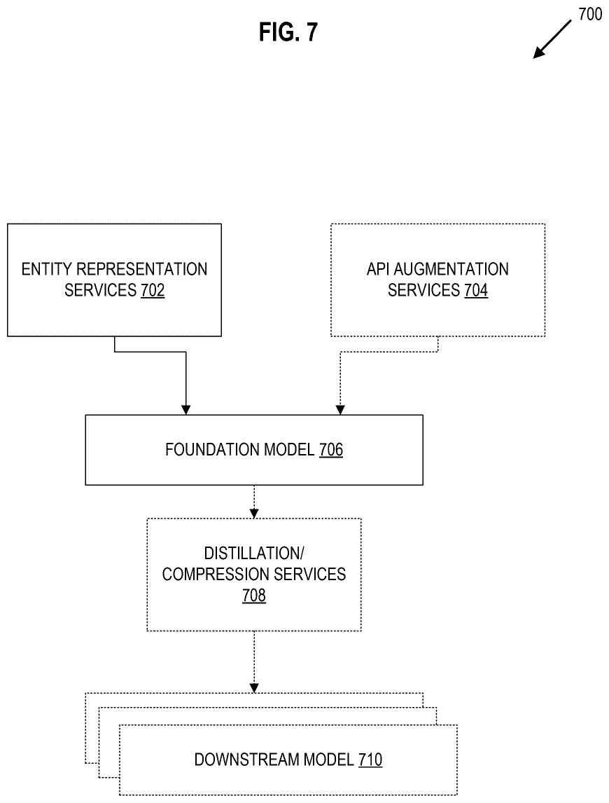

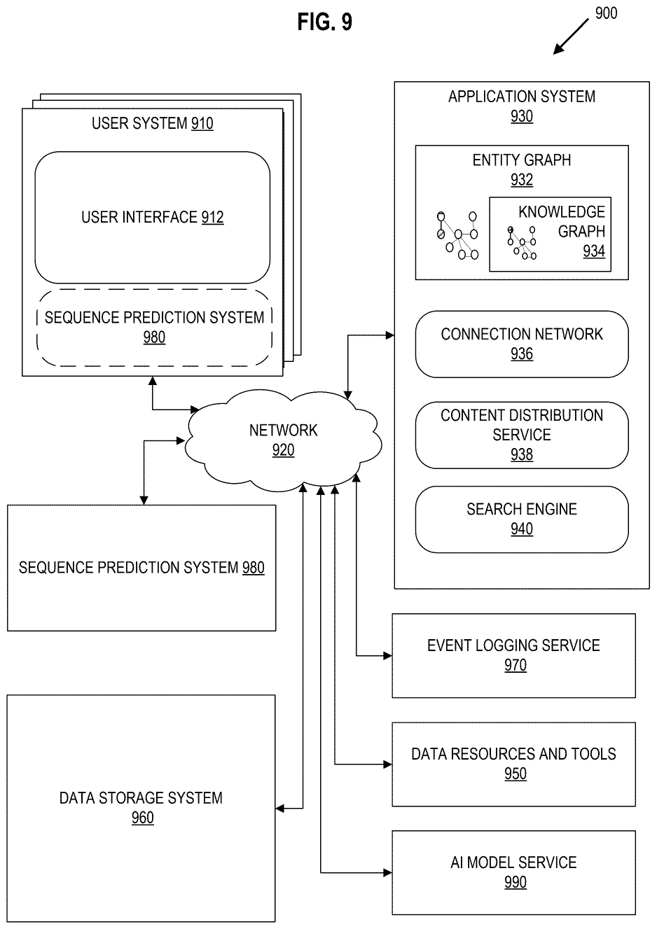

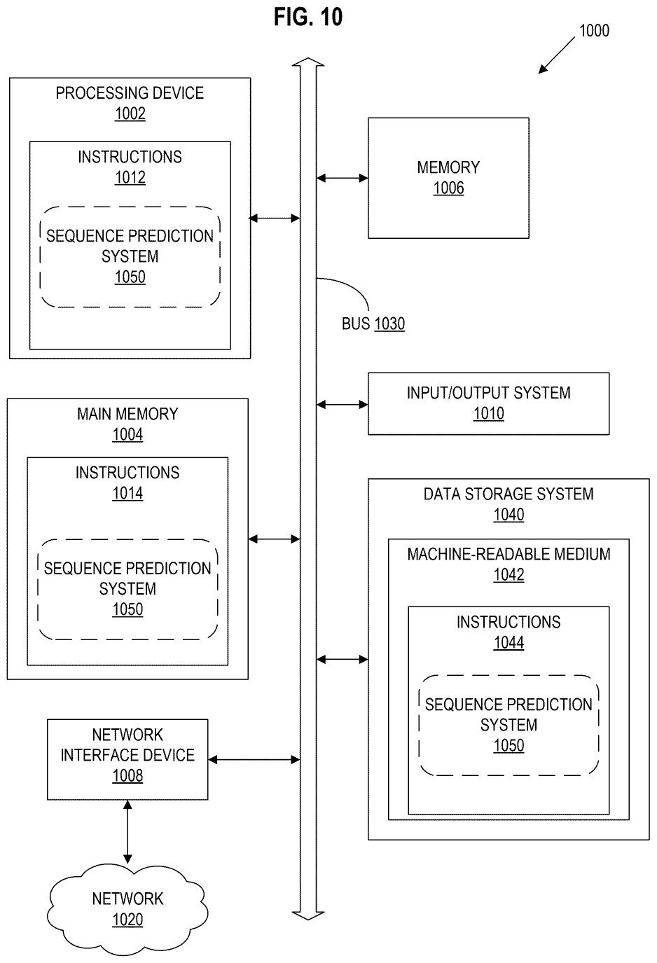

FIG. 1 is a component-based flow diagram of an example method for training a neural network to predict an action sequence in accordance with some examples of the present disclosure. The model training method 100 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, portions of the model training method 100 are performed by one or more computing system components shown in FIG. 1, FIG. 2, FIG. 3, FIG. 5, FIG. 6, FIG. 7, computing system 900 of FIG. 9, or computer system 1000 of FIG. 10. Although shown in a particular sequence or order, unless otherwise specified, the order of the processes is modified in some examples. The processes are performed in a different order, and some processes are performed in parallel, in some examples. One or more processes are omitted in various examples. Not all processes are required in every example. Other process flows are possible.

In FIG. 1, the model training method 100 is represented by arrows connecting components of a computing system. The illustrated computing system includes an environment 101, an application interface 102, and a sequence prediction system 103. The environment 101, application interface 102 and sequence prediction system 103 are implemented using at least one computing device, such as an application server or server cluster, for the processing of electronic transmissions or signals, including transmissions of data and transmission of instructions. In some examples, the environment 101, application interface 102 and/or sequence prediction system 103 includes a secure environment (e.g., secure enclave, encryption system, etc.) In some examples, portions of the sequence prediction system 103 are implemented on a client device, such as a user system 910, described with reference to FIG. 9. In some examples, some or all of sequence prediction system 103 is implemented directly on a user's device or within an embedded system, thereby avoiding the need to communicate with servers over a network such as the Internet.

The environment 101 includes one or more user devices 101A, a network 101B, and/or one or more sensing devices 101C. Examples of user devices 101A include computing devices, such as laptop computers, smart phones, mobile or portable computing devices, smart appliances, wearable devices, game controls, vehicle controls, robotic devices, semi-autonomous devices, and other types of devices. Examples of networks 101B include wireless, optical, and wired communication networks. Examples of sensing devices 101C include motion sensors, load cells, force sensors, light sensors, angle sensors, accelerometers, gyroscopes, temperature sensors, physiological sensors, energy sensors, network sensors, and other types of sensing devices.

The application interface 102 includes an application layer, presentation layer, and/or data layer of an application software system, such a device control system, network security application, application system 930 described with reference to FIG. 9, or another type of application software system. The application interface 102 manages and facilitates electronic and/or electromagnetic communications (e.g., digital and/or analog signals) between the environment 101 and the sequence prediction system 103.

Responsive to receiving electronic transmissions (e.g., data signals and/or control signals) via one or more components of the environment 101, the application interface 102 stores the data signals and/or control signals using one or more data stores. In some examples, descriptive content 104 is stored in a first data store (e.g., a searchable database or repository of documents or web pages), action sequences 106 are stored in a second data store (e.g., a real-time data store for streaming data such as a log file), and graph connections are stored in a third data store (e.g., a graph database storing graph connections 108).

Examples of descriptive content 104 include digital content items such as entity profile pages, articles, documents (e.g., resumes, training materials, manuals, brochures, etc.), videos, images, etc. that provide information about a given entity. In some examples, descriptive content 104 includes content that is applicable to multiple different tasks, such as entity profile information, information about an entity's preferred devices (e.g., web or mobile), etc.

Examples of action sequences 106 include logs of entity interactions with the application software system. In some examples, an entry in the log includes structured data that identifies a first entity (e.g., entity E1), an action taken by the first entity within the application software system (e.g., action A1), a second entity involved in the action (e.g., entity E2), an indication of whether or not an action was taken by the first entity during the action (e.g., 0 if no action, 1 if there was an action), and a timestamp associated with the log entry (e.g., timestamp t1), e.g., as a row of comma delimited values. In some examples, the action taken by the first entity involves an electronic transmission from the first entity to the second entity such that an action includes at least one entity.

Logging an action is done actively or passively in various embodiments. In some examples, use of a software application is not needed for logging an action, such as if the use relates to an interaction with an external application (e.g., an application other than the platform using the described model, such as an application that has access to the platform via an API).

In the example of FIG. 1, the action sequence 106 is specific to an entity (e.g., entity E1). Each row in an action sequence 106 indicates an occurrence of an action, and any action sequence 106 includes the entire sequence of actions in the log or a subsequence of the entire action sequence. In some examples, the action sequence includes actions that relate to multiple different tasks, e.g., at least two of a first action that relates to an entity search, a second action that relates to a feed, a third action that relates to a post, a fourth action that relates to a notification, etc.

Action sequence 106 includes historical data, including combinations of actions, some of which may be associated with different types of tasks. In some examples, action sequence 106 includes a history of actions related to job searching, profile updates, and connection requests for a user who is interested in finding a new job. In some examples, action sequence 106 includes a history of actions related to different types of financial transactions and user accounts monitored by a fraud detection system. In some examples, action sequence 106 includes a history of network communications sent out over a network being monitored by a network security system. In some examples, action sequence 106 includes a historical sequence of movements performed by a physical device such as a robot or vehicle.

Graph connections 108 include structured data about relationships between entities that interact with one another via the application software system. In some examples, entity relationships are represented in graph form using nodes to represent entities and edges connecting the entities to represent the relationships between the entities.

Examples of graph connections 108 include histories of logical or physical connections between entities. In some examples, graph connections 108 include connections that a user has made with other users of an application software system, such as friend or follower connections, or connections a user has made with digital content items distributed via an application software system, such as likes, shares, comments, or other reactions. In some examples, graph connections 108 include a history of connections between physical or logical devices on a network, such as user accounts connected to an application via a network portal. In some examples, graph connections 108 include a history of connections between components of a physical device such as components of a vehicle navigation system or robotic end effector control system. In some examples, graph connections 108 include portions of entity graphs, such as entity graph 200 described with reference to FIG. 2, or entity graph 932 and/or knowledge graph 934 described with reference to FIG. 9.

In an example of the model training method 100, the sequence prediction system 103 prepares model training data (e.g., training input 126, training batch 130) using a combination of descriptive content 104 and one or more of action sequence 106 and graph connections 108. The model training method 100 trains a neural network model (e.g., neural network with attention 132) using the prepared training data.

To prepare the training data and train the model, sequence prediction system 103 includes a natural language (NL) representation generator 110, a training input generator 114, a neural network trainer 128, a neural network with attention 132, and a model evaluator 136. After a successful completion of the model training method (e.g., as determined by the model evaluator 136), the trained model is provided to a model serving interface 140.

In the model training method 100, for a given entity with an associated entity identifier, e.g., entity E1, the natural language representation generator 110 converts action sequences 106 and/or graph connections 108 associated with the entity identifier to natural language (NL) representations 112 which are a natural language or textual form. In some examples, natural language representation generator 110 uses a first conversion method when the input is action sequence 106 and a second conversion method different from the first conversion method when the input is graph connections 108.

In some examples, the descriptive content 104 bypasses the natural language representation generator 110 when the descriptive content 104 already is in a natural language or textual form and does not contain any entity identifiers. Alternatively or in addition, irrespective of whether the descriptive content is already in a natural language or textual form or contains entity references, the descriptive content 104 is used by the natural language representation generator 110 to generate the NL representations 112 of the action sequence 106 and/or the NL representations 112 of the graph connections 108.

In response to the input to natural language representation generator 110 including an action sequence 106, in some examples, natural language representation generator 110 uses a combination of pre-defined templates, descriptive content 104, and the action sequence 106 to generate and output an NL representation 112 of the action sequence 106 for the entity associated with the action sequence 106. The NL representation 112 of the action sequence 106 for the entity, produced by the natural language representation generator 110, includes a natural language or textual description of the entity's action sequence 106. For a hypothetical entity, such as a user of an application system with a user identifier (ID) of user_1234, an example NL representation 112 of the user's action sequence 106 includes:
“User with user_id_1234 <full_user_profile> has applied for a job_566 with job title <job_title> and job description <full_job_description> on Sep. 20, 2023 at time 12 pm. This user also spent 20 seconds on post_123 <post_description> on the same day at time 11:30 am and liked the post_767 <post_description> same day at time 11:00 am. On September 10th, this user commented on the post_1010 <post_description> with author <user_id> at time 4:00 pm . . . ”

In the example NL representation 112 above, referential entity identifiers are mixed in with natural language or textual content, e.g., user_id_1234, job_566, post_123, post_767 are each a unique identifier that acts as a reference to a different entity. Some of the entity identifiers are associated with different entity types; for instance, users, posts, and job listings are different types of entities and have different types of entity identifiers.

In the example NL representation 112 above, brackets “< >” indicate that the text within the brackets is a placeholder for information that is to be obtained via the preceding entity identifier. For instance, job_title is a place holder for the job title of the job identified by the job_566 entity identifier. The job title is determined by querying a data record (e.g., an entity profile record, such as descriptive content 104) associated with the job_566 entity identifier to obtain the job title.

During the training data preparation portion of the model training method 100, the training input generator 114 tokenizes the entity identifiers and bracketed content differently from other portions of the descriptive content 104 and NL representation 112 of the action sequence 106. These differently tokenized portions of the descriptive content 104 and NL representation 112 of the action sequence 106 are converted into separate embeddings using different embedding generators as described in more detail below.

In response to the input to natural language representation generator 110 including graph connections 108, in some examples, natural language representation generator 110 uses graph modeling techniques to verbalize the graph connections 108 in natural language or textual form. In some examples, the graph connections 108 are processed by a big graph engine. The graph engine is used to execute a graph alignment process, e.g., graph join and aggregation in multi-hop, on the graph connections 108 to produce graph structure output. A decoder generates natural language or textual content that describes the graph connections 108 from the graph engine output. An example of such description is: “User_123 is connected to the following users: user_235, user_673, user_6431.” When the graph connections 108 contain referential entity identifiers, the NL representation 112 of graph connections 108 retains those entity identifiers mixed in with the natural language or textual description of the graph connections 108.

During the training data preparation portion of the model training method 100, the training input generator 114 tokenizes the entity identifiers and/or other reserved words differently from other portions of the NL representation 112 of the graph connections 108. These differently tokenized portions of the NL representation 112 of the graph connections 108 are converted into separate embeddings using different embedding generators as described in more detail below.

In some examples, natural language representation generator 110 uses application programming interface (API) augmentation to supplement the information contained in descriptive content 104, action sequence 106, and/or graph connections 108. In some examples, API calls are included in the NL representations 112 so that when the NL representations 112 are read by the training input generator 114, the API calls are executed to obtain the latest updates to the action sequence 106 and/or graph connections 108, as the case may be. In some examples, special tokens such as [API_graph] and [/API_graph] are used to make the start and end of an API call within the NL representations 112. The described API augmentation technique improves the freshness of the data used to train the neural network with attention 312 by enabling recently updated information to be obtained and incorporated in to the NL representations 112 at training/update time.

In some examples, the natural language representation generator 110 includes a mediation process through which the completeness and/or freshness (e.g., recency) of the action sequence 106 and/or graph connections 108 is evaluated. In some examples, in response to determining that the action sequence 106 is empty or only contains a small number of actions (e.g., less than or equal to two actions), the mediation process initiates the process of generating an NL representation 112 of the graph connections 108, such that the graph connections 108 are used to supplement or replace the action sequence 106.

In some examples, in response to the mediation process determining that the number of actions in the action sequence 106 satisfies a threshold number of actions, the mediation process generates NL representations 112 for the action sequence 106 and skips the step of generating NL representations 112 for the graph connections 108. The threshold number of actions is configurable in accordance with requirements of a particular design or implementation of the model training method 100.

In some examples, in response to determining that the graph connections 108 are empty or only contain a small number of connections (e.g., one or more connections), the mediation process initiates the process of generating an NL representation 112 of the action sequence 106, such that the action sequence 106 is used to supplement or replace the graph connections 108.

In some examples, in response to the mediation process determining that the number of connections in graph connections 108 satisfies a threshold number of graph connections, the mediation process generates NL representations 112 for the graph connections 108 and skips the step of generating NL representations 112 for the action sequence 106. The threshold number of graph connections is configurable in accordance with requirements of a particular design or implementation of the model training method 100.

In some examples, in response to determining that a pre-defined time interval has passed since the last model update, the mediation process obtains an updated action sequence 106 and/or the graph connections 108 that have been created or logged since the last model update, and natural language representation generator 110 creates the respective NL representations 112 using one or more of the processes described above. The length of the pre-defined time interval is configurable in accordance with the requirements of a particular design or implementation of the model training method 100.

To train the neural network with attention 132, the training input generator 114 creates training input 126 for a given entity from the descriptive content 104 and NL representations 112 for that entity. In some examples, an instance of training input 126 includes, for a given entity, an input and an output that the model is expected to produce in response to the input (e.g., an input-output pair). In some examples, the input of the input-output pair includes a first action sequence and context, where the first action sequence includes a historical action sequence (e.g., a first subsequence of action sequence 106) associated with the entity ID and the context includes descriptive content 104 and/or graph connections 108 associated with the entity ID. In some examples, the output of the input-output pair includes a second action sequence, where the second action sequence is an action sequence that the model is expected to predict would occur next, given the first action sequence and context (e.g., a second subsequence of action sequence 106 that follows the first subsequence).

To prepare the training input 126 for ingestion by the neural network with attention 132, the training input generator 114 converts combinations of descriptive content 104 and NL representations 112 into tokenized forms using tokenizers. Tokenizers are computer functions that transform raw data, e.g., natural language or textual content, into structured formats that a machine learning model can ingest and process, e.g., a sequence of tokens. A token is a portion of digital content that includes one or more characters, e.g., a single character, a sub-word, a complete word, a sentence fragment, or a sentence. Tokenizers often divide input containing natural language content or textual into smaller sub-units of the input to facilitate downstream processing by machine learning models. Different tokenizers use different processes for breaking down natural language content or textual into differently-sized tokens. The process used by a tokenizer to convert natural language or textual content into tokens affects the way that the machine learning model processes the tokenized input.

To convert a combination of descriptive content 104 and NL representations 112 into a tokenized form, the training input generator 114 includes a first tokenizer 116 and a second tokenizer 120. The first tokenizer 116 has an associated first or standardized vocabulary 118. The second tokenizer 120 has an associated second or non-standardized vocabulary 122.

In some examples, the first tokenizer 116 is a standardized tokenizer such as a SentencePiece tokenizer, with the first vocabulary 118 containing a standard vocabulary, such as the vocabulary provided with the SentencePiece tokenizer. The second tokenizer 120 is a non-standardized or customized tokenizer, with the second vocabulary 122 containing a non-standardized or customized vocabulary. In some examples, the second vocabulary 122 includes words that have a special meaning in the context of a particular domain or task, e.g., reserved words. Examples of reserved words include, in the job search context, “apply” and “job.” Other examples of reserved words include various types of entity identifiers, e.g., user_ID, job_ID, post_ID, device_ID, network_ID, etc.

During the tokenization portion of the model training method 100, the first tokenizer 116 converts portions of the descriptive content 104 and NL representations 112 that do not correspond to reserved words of the second vocabulary 122 into content tokens 117 in accordance with the first vocabulary 118, and the second tokenizer 120 converts portions of the descriptive content 104 and NL representations 112 that correspond to reserved words into entity tokens 121 in accordance with the second vocabulary 122.

For example, if “apply” is a reserved word and that word is encountered in the descriptive content 104 or NL representations 112, then the first tokenizer 116 does not process the word “apply” (e.g., the first tokenizer 116 does not create sub word-based tokens such as “appl” or “app” from the word “apply”). Instead, the second tokenizer 120 creates a word-based token that contains the entire word, “apply.” Similarly, if an entity ID is encountered in the descriptive content 104 or NL representations 112, then the first tokenizer 116 does not attempt to create sub word-based tokens for the entity ID. Instead, the second tokenizer 120 creates a word-based token that contains the entire entity ID.

The first tokenizer 116 outputs content tokens 117 for portions of the descriptive content 104 and NL representations 112 that are not tokenized by the second tokenizer 120. The second tokenizer 120 outputs entity tokens 121 for portions of the descriptive content 104 and NL representations 112 that are not tokenized by the first tokenizer 116.

The training input generator 114 converts the tokenized input, e.g., content tokens 117 and entity tokens 121, into respective embeddings, using different embedding generators. An embedding includes a numerical representation of an input generated by a trained machine learning model. An embedding generator includes a machine learning model that encodes an input into an embedding space, e.g., a lower-dimensional embedding space. As such, an embedding can represent the contents of the input in a more compact or compressed form than the original input. An embedding can be expressed as a vector, where each dimension of the vector includes a numerical value that can be an integer or a real number (e.g., a floating point number). The numerical value assigned to a given dimension of the vector conveys information about the data represented by the embedding, relative to the embedding space. The embedding space is defined by the way in which the machine learning model used to generate the embedding has been configured including the training data used to train the machine learning model.

To convert the tokenized input, e.g., content tokens 117 and entity tokens 121, into respective embeddings, e.g., content embeddings 123 and entity embeddings 127, the training input generator 114 includes a content embedding generator 119 and an entity embedding generator 125.

The content embedding generator 119 takes as input the content tokens 117 and generates and outputs content embeddings 123 corresponding to the content tokens 117. In some examples, the content embedding generator 119 generates and outputs a content embedding 123 for each content token 117. In some examples, the content embedding generator 119 includes a machine learning model that has been trained on a large corpus of natural language or textual content (e.g., millions or billions of documents and/or other forms of digital content containing natural language or textual content). In some examples, the content embedding generator 119 is part of the neural network with attention 132, e.g., as part of an input layer or embedding layer of the neural network with attention 132. The content embeddings 123 are stored in a content embedding store such as content embedding store 512 described with reference to FIG. 5 or content embedding store 616 described with reference to FIG. 6.

The entity embedding generator 125 takes as input the entity tokens 121 and generates and outputs entity embeddings 127 corresponding to the entity tokens 121. In some examples, the entity embedding generator 125 generates and outputs an entity embedding 127 for each entity token 121. In some examples, the entity embedding generator 125 includes a machine learning model that has been trained on a corpus of task- and/or domain specific training data, such as data records obtained from a specific application software system.

The training data used to train the entity embedding generator 125 is different from the training data used to train the content embedding generator 119, e.g., the content embedding generator 119 is trained using a first training data set and the entity embedding generator 125 is trained using a second training data set different from the first training data set. As a result, the content embedding generator 119 uses a first embedding space to generate the content embeddings 123 and the entity embedding generator 125 uses a second embedding space to generate the entity embeddings 127, where the second embedding space is different from the first embedding space. In some examples, where the entity tokens 121 contain different types of entity IDs, the same entity embedding generator 125 is used to generate the corresponding entity embeddings 127 irrespective of the type of entity ID. For instance, the same entity embedding generator 125 is used to generate entity embeddings 127 whether the entity ID identifiers a user, a post, a notification, a job listing, a device type, etc.

To generate an entity embedding 127, the entity embedding generator 125 does not generate an embedding only for the raw entity ID. Instead, the entity embedding generator 125 generates the entity embedding 127 using the entity ID and the context associated with the entity ID. For instance, the entity embedding generator 125 uses the entity ID to query one or more data sources (e.g. data storage system 960 and/or data resources and tools 950, described with reference to FIG. 9) to obtain the entity-specific context (e.g., descriptive content 104, action sequence 106, graph connections 108, and/or NL representations 112), and includes the entity-specific context along with the entity ID in the input to the embedding generation process. Thus, in some examples, the resulting entity embedding 127 includes a holistic, cross-task representation of the entity associated with the corresponding entity ID.

In some examples, the entity embedding generator 125 is external to the model training method 100 or sequence prediction system 103, e.g., accessible via an API call to an AI model service 990, described with reference to FIG. 9. The entity embeddings 127 are stored in one or more entity embedding stores, such as entity embedding stores 514 described with reference to FIG. 5 or entity embedding store 616 described with reference to FIG. 6. In some examples, a different embedding store is provided for each entity type or for each entity ID, depending on the latency or efficiency requirements of a particular design or implementation.

In some examples, an entity embedding table, such as entity embedding table 506 described with reference to FIG. 5 or entity embedding table 606 described with reference to FIG. 6, is created as part of the model training method 100 or the entity embedding generation process, if the entity embedding generation process is external to the model training method 100 or sequence prediction system 103. The entity embedding table is usable as an index, e.g., to efficiently look up and/or retrieve entity embeddings associated with specified entity IDs.

To create the training input 126 from the content embeddings 123 and entity embeddings 127, the training input generator 114 includes shared projection layer 124. A projection layer in neural networks refers to a layer that transforms input data into a different dimensional space to product a projection vector in accordance with the design and goals of the neural network. The primary function of a projection layer is to map the input into a new representation that may be more suitable for the subsequent tasks or layers. For instance, the projection layer may increase the dimensionality of the input, e.g., to capture more complex patterns, or reduce the dimensionality of the input, e.g., to compress the data, reduce noise, or optimize network performance for a specific task. In a shared projection layer, the same set of weights is applied to each occurrence of the same input so that each word may contribute changes to the weight values.

The content embeddings 123 and entity embeddings 127 for a given entity ID are input to the shared projection layer 124. The shared projection layer 124 aligns the entity embeddings 127 with the content embeddings 123 to produce a projection vector, which becomes the training input 126 for the entity ID.

In some examples, the training input generator 114 repeats the above-described process of creating training input 126 for each entity ID in a set of multiple entity IDs. The training input generator 114 uses the same process to create training input 126 irrespective of the entity type or task. For instance, the training input generator 114 may create a first training input 126 for a user of an application software system, a second training input for a content item distributed via the application software system, a third training input for a device connected to a network, etc., using the above-described process.

In some examples, portions of the training input generator 114, e.g., one or more of the first tokenizer 116, first vocabulary 118, and content embedding generator 119 are included in the architecture of the neural network with attention 132, e.g., as part of an input layer of the neural network with attention 132, and one or more of the second tokenizer 120, second vocabulary 122, entity embedding generator 125, and shared projection layer 124 are operably coupled to the neural network with attention 132 as extensions to the model architecture.

In some examples, shared projection layer 124 removes absolute position (e.g., spatial position) information from the content embeddings 123 and entity embeddings 127 as part of the process of preparing the training input 126 to effectively disable or omit any encoding of absolute (e.g., spatial) position in the training input 126. For instance, portions of the content embeddings 123 and entity embeddings 127 that contain absolute position information may be set to zero values. In other examples, content embeddings 123 and entity embeddings 127 do not contain absolute position information such that absolute position information does not need to be removed or zeroed out from the content embeddings 123 and entity embeddings 127.

To train the neural network with attention 132 using the training input 126 generated by the training input generator 114 as described, the neural network trainer 128 obtains the training input 126 from the training input generator 114 or from a data store used by the training input generator 114 to at least temporarily store the instances of training input 126 as they are created. As discussed above, an instance of training input 126 includes an input-output pair, where the output portion of the input-output pair is an output that the neural network with attention 132 would be expected to produce given the corresponding input of the input-output pair. The input-output pairs are designed to cause the neural network with attention 132 to establish statistical correlations between different inputs and outputs through the model training process. More specifically, the training input 126 includes unique entity identifiers, and the input-output pairs are designed to cause the neural network with attention to establish correlations between different inputs, including the unique entity IDs, and outputs, through the model training process.

In some examples, the neural network trainer 128 groups the instances of training input 126 into one or more training batches 130 and uses the one or more training batches 130 to train the neural network with attention 132 in coordination with the model evaluator 136. For instance, the neural network trainer 128 groups instances of training input 126 by entity ID, task, or time interval, to create the one or more training batches 130. The neural network trainer 128 causes a training batch 130 to be input to the neural network with attention 132. During the model training process, in response to the training batch 130, the neural network with attention 132 processes the input portion of the training input 126 and produces model output in response to the input portion of the training input 126, where the model output is an estimated or predicted output generated by the neural network with attention 132. The model output is combined with the respective training input 126 to produce a training input-model output pair 134 for each training input 126 in the training batch 130.

In the model training method 100, the neural network trainer 128 iteratively applies the neural network with attention 132 to training batches 130. The neural network with attention 132 includes a deep neural network with an attention mechanism. In some examples, the neural network with attention 132 includes a recurrent neural network (RNN) with an attention mechanism. A recurrent neural network is a type of neural network that is usable to model sequential data. In some examples, the neural network with attention 132 includes a convolutional neural network with an attention mechanism. A convolutional neural network is a type of neural network that is usable to model grid-like data such as data with two- or three-dimensional coordinates.

In some examples, the neural network with attention 132 includes a sequence-to-sequence model, such as an encoder-decoder model. An encoder-decoder model is a type of sequence-to-sequence neural network model that can process sequential inputs and produce sequential outputs. In an encoder-decoder model, the encoder converts a variable-length input sequence into a fixed-length representation, and the decoder uses the fixed-length representation of the input sequence to generate an output sequence. An example including an encoder-decoder model is described with reference to FIG. 5.

In some examples, the neural network with attention 132 includes a transformer model. A transformer model is a type of encoder-decoder model that uses attention mechanisms to assign different weight values to different words or tokens in an input sequence when generating predictive outputs, where a higher weight value corresponds to a higher predicted importance of the word/token and a lower weight value corresponds to a lower predicted importance of the word/token, relative to other portions of the input sequence. An example including a transformer model is described with reference to FIG. 6.

If the neural network with attention 132 includes a position encoder, e.g., as described with reference to FIG. 5 or FIG. 6, the position encoder is disabled or omitted during the model training method 100. Disabling or omitting the position encoder prevents the model from assigning weights to portions of the training input 126 based on absolute position. In some examples, the position encoder is disabled or omitted by manipulation of the training input 126, e.g., as described above. In other examples, the position encoder is disabled or omitted programmatically, e.g., as described with reference to FIG. 5 or FIG. 6.

In the model training method 100, the model evaluator 136 evaluates the training input-model output pairs 134 produced by the neural network with attention 132 using a loss function. The loss function is designed to determine whether the model output is converging toward the expected output or to evaluate some other model performance criterion. For example, the output of the loss function indicates how much the difference between the model output and expected output changes from one iteration to another.

Examples of loss functions usable in connection with the model training method 100 include supervised task loss, self-supervised task loss, causal language model loss, and reinforcement learning with human feedback (RLHF). The supervised task loss involves training the model based on specific prompts and the expected supervised output. In some examples, the supervised task loss includes determining whether a member has interacted with a piece of content. Examples of such losses include, but are not limited to, supervised sequential loss, such as dense all-action loss, and cross-entropy classification tasks. In the case of self-supervised loss, the model is trained directly from the data itself to discern patterns within it. The self-supervised loss training method involves masking a portion of the input prompt (such as user interaction history, e.g., action sequence 106) and causing the model to predict the masked content, potentially along with other user information in the data. Examples of self-supervised losses include next token prediction and mask token prediction. Causal Language Model loss is akin to the next sentence prediction in LLM models. The causal language model loss function aids in capturing contextual relationships and sequential dependencies within the input data, contributing to a more comprehensive understanding of the language structure.

In reinforcement learning with human feedback (RLHF), human feedback is used to evaluate and improve the quality of the model output. In some examples, RLHF is used to align the model behavior with human preferences and instructions. In some examples, RLHF is used to improve the ranking accuracy of the trained neural network with attention 132. In examples that use RLHF, the model evaluator 136 includes a mechanism for collecting human feedback, implementing reinforcement learning strategies to fine-tune the neural network with attention 132, and iterate the RLHF, potentially continuously to keep the model aligned with user feedback.

The model evaluator 136 includes a decision block 138. The decision block 138 evaluates the performance of the neural network with attention 132 and determines whether to continue the model training method 100 or conclude the model training method 100. In response to the model evaluator 136 determining to continue the model training method 100, the model training method 100 returns to the neural network trainer 128.

In some examples, the neural network trainer 128 in coordination with the model evaluator 136 uses a freeze/unfreeze training strategy to train the neural network with attention 132. Freezing a layer of a neural network during training refers to a process by which the values of trainable parameters of that layer are fixed and not changed (“frozen”) during the training. Unfreezing a layer means that, during training, a layer whose trainable parameters were previously frozen are now enabled to have their values adjusted during the training. Different layers of the neural network can be frozen and unfrozen during the training to improve the model performance.

In some examples, output of decision block 138 of the model evaluator 136 is used by the neural network trainer 128 to determine whether to freeze or unfreeze one or more layers of the neural network with attention 132. In some examples, in response to the model evaluator 136 determining that the model performance does not satisfy a model performance criterion, e.g., the output of the loss function exceeds a threshold value, the model training method 100 returns to the neural network trainer 128, the neural network trainer 128 adjusts the freeze/unfreeze training strategy and/or applies the neural network with attention 132 to one or more additional training batches 130.

As a result of the model training method 100, the neural network with attention 132 includes, for each unique entity ID in the training input 126, a set of one or more trained parameters that are specific to the corresponding entity ID. Also as a result of the model training method 100, weights are assigned to combinations of reserved words and/or entity IDs based on the relative position of the reserved words and/or entity IDs in the training input 126 (rather than based on absolute position), e.g., based on information encoded in the entity embeddings 127. During training, the neural network with attention 132 uses the timestamp data extracted from the action sequence 106 to determine the relative positions of reserved words and/or entity IDS in the training input 126.

For instance, a first training input may contain a representation of the words “search,” “click,” and “apply,” with the associated timestamp data indicating that “search” appears in the input before “click,” and both “search” and “click” occur before “apply” (relative position). This information about the relative position of the different portions of the training input is evaluated during model training independently of or without regard to the absolute position of those words (e.g., irrespective of whether “click” occurs at the beginning of the input sequence, “search” occurs in the middle of the input sequence, and “apply” occurs in the middle or at the end of the input sequence). As a result of the model training method 100, this first training input, in which “search” and “click” occur before “apply” may be weighted more highly by the neural network with attention 132 than a different training input that includes “click” and “search” but does not include “apply” or only includes “apply” or includes “apply” before “click” instead of “click” before “apply.”

In response to the model evaluator 136 determining to conclude the model training method 100, the model training method continues to model serving interface 140; e.g., the model training method 100 sends a communication to the model serving interface 140 that a trained neural network with attention 132 is available for serving via the model serving interface 140.

Model serving interface 140 includes or is connected to, e.g., a hosted platform such as AI model service 990 described with reference to FIG. 9. Model serving interface 140 makes trained versions of the neural network model with attention 132 accessible by one or more components of the environment 101, e.g., via application interface 102. In some examples, model serving interface 140 provides a library of API calls that are usable by, e.g., application interface 102 or one or more other devices, networks, models, systems, etc., to communicate with a trained version of the neural network model with attention 132.

The examples shown in FIG. 1 and the accompanying description are provided for illustration purposes. This disclosure is not limited to the described examples.

FIG. 2 is an example of an entity graph in accordance with some embodiments of the present disclosure. An entity graph 200 includes nodes, edges, and data (such as labels, weights, or scores) associated with nodes and/or edges. In some examples, nodes are weighted based on edge counts, and edges are weighted based on commonalities between the nodes connected by the edges, such as common attribute values (e.g., two users have the same job title or employer, two devices are of the same type, etc.).

A graphing mechanism is used to create, update and maintain the entity graph 200. In some implementations, the graphing mechanism is a component of the database architecture used to implement the entity graph 200. In some examples, the graphing mechanism is a component of a data storage system and/or application software system (e.g., data storage system 960 and/or application system 930, described with reference to FIG. 9, and the entity graphs created by the graphing mechanism are stored in one or more of the data stores of the data storage system.

In the example of FIG. 2, entity graph 200 includes nodes 202, 204, 206, 208, 210, 212, 214, 216, 218, and 220. As indicated in the legend, the nodes 202, 204, 206, 208, 210, 212, 214, 216, 218, and 220 represent various entities of different entity types. For instance, in FIG. 2, nodes 202, 204, 206, and 208 represent entities of a first entity type (e.g., users of an online system); node 212 represents an entity of a second entity type (e.g., a post), nodes 210 and 216 represent entities of a third entity type (e.g., a job listing); nodes 214 and 220 represent entities of a fourth entity type (e.g., a feed item), and node 218 represents an entity of a fifth entity type (e.g., a notification). In other examples, the nodes 202, 204, 206, 208, 210, 212, 214, 216, 218, and 220 represent entities of other entity types, such as devices, networks, subcomponents of devices, communication channels, etc.

Entity graph 200 includes edges 222, 224, 226, 228, 230, 232, 234, 236, 238, 240, 242, 244, 246, 248. The edges 222, 224, 226, 228, 230, 232, 234, 236, 238, 240, 242, 244, 246, 248 individually and/or collectively represent various different types of relationships between or among the nodes 202, 204, 206, 208, 210, 212, 214, 216, 218, and 220. In some examples, descriptive content, such as profile information, is linked with nodes and edges. Each node is assigned a unique entity identifier (or node identifier) and each edge is assigned a unique edge identifier. In some examples, the edge identifier is a combination of the entity identifiers of the nodes connected by the respective edges and a timestamp that indicates the date and time at which the edge was created.

In some examples, edges between user nodes, such as edges 222, 228, 234, represent online social connections between the users represented by the nodes, such as ‘friend’ or ‘follower’ connections between the connected nodes. For instance, in the entity graph 200, user node 204 is a first-degree connection of user node 202 and user node 206, while user node 206 is a second-degree connect of user node 202, and user node 208 is a first degree connection of user node 206 and a third-degree connection of user node 202.

In some examples, edges represent activity involving the nodes connected by the edges. For instance, user node 202 is connected to post node 212 by edge 240 because the user associated with the user node 202 has viewed or clicked on the post represented by the post node 212 in an online system (e.g., application system 930). User node 206 is connected to feed item nodes 214 and 220 by respective edges 230 and 242, because the user associated with the user node 206 has viewed or clicked on the feed items represented by the feed item nodes 214 and 220. Edge 248 is created between user node 206 and job listing node 210 because the user represented by user node 206 submitted an application for the job represented by the job listing node 210. In other examples, edges are created when users log into networks or online systems, or when connections are made between different components of a device or system.

The examples shown in FIG. 2 and the accompanying description are provided for illustration purposes. This disclosure is not limited to the described examples.

FIG. 3 is a component-based flow diagram of an example method for predicting an action sequence using a neural network in accordance with some examples of the present disclosure.

The action sequence prediction method 300 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, portions of the action sequence method 300 are performed by one or more computing system components shown in FIG. 1, FIG. 2, FIG. 3, FIG. 5, FIG. 6, FIG. 7, one or more components of computing system 900 of FIG. 9, or computer system 1000 of FIG. 10. Although shown in a particular sequence or order, unless otherwise specified, the order of the processes is modified in some examples. The processes are performed in a different order, and some processes are performed in parallel, in some examples. Additionally, one or more processes are omitted in various examples. Not all processes are required in every example. Other process flows are possible.

In FIG. 3, the action sequence prediction method 300 is represented by arrows connecting components of a computing system. The illustrated computing system includes one or more components of an environment 301, an application interface 302, and a sequence prediction system 303.

The application interface 302 and sequence prediction system 303 are implemented using at least one computing device, such as an application server or server cluster, for the processing of electronic transmissions or signals, including transmissions of data and transmission of instructions. In some examples, application interface 302 and/or sequence prediction system 303 includes a secure environment (e.g., secure enclave, encryption system, etc.) In some examples, one or more components of the sequence prediction system 303 are implemented on a client device, such as a user system 910, described with reference to FIG. 9. In some examples, some or all of sequence prediction system 303 is implemented directly on a user's device or within an embedded system, thereby avoiding the need to communicate with servers over a network such as the Internet.

The environment 301 includes one or more user devices 301A, a network 301B, and/or one or more sensing devices 301C. Examples of user devices 301A include computing devices, such as laptop computers, smart phones, mobile or portable computing devices, smart appliances, wearable devices, game controls, vehicle controls, robotic devices, semi-autonomous devices, and other types of devices. Examples of networks 301B include wireless, optical, wired, and other types of networks. Examples of sensing devices 301C include motion sensors, load cells, force sensors, light sensors, temperature sensors, physiological sensors, energy sensors, network sensors, and other types of sensing devices.

The application interface 302 is or includes an application layer, presentation layer, and/or data layer of an application software system, such as application system 930 described with reference to FIG. 9 or another type of application system. The application interface 302 manages and facilitates electronic and/or electromagnetic communications between the environment 301 and the sequence prediction system 303, e.g., via a model serving interface 304.

The sequence prediction system 303 includes model serving interface 304, a model input generator 314, a trained neural network with attention 328, a model evaluator 330, and a model serving interface 340.

The model serving interface 304 includes or is connected to, e.g., a hosted platform such as AI model service 990 described with reference to FIG. 9. Model serving interface 304 makes trained versions of the neural network model with attention 328 accessible by one or more components of the environment 301, e.g., via application interface 302. In some examples, model serving interface 304 provides a library of API calls that are usable by, e.g., the application interface 302 or one or more other devices, networks, models, systems, etc., to communicate with the trained version of the neural network model with attention 328. In some examples, model serving interface 340 is or includes model serving interface 304 but is shown separately in FIG. 3 for ease of illustration.

In the action sequence prediction method 300, the model input generator 314 receives input, e.g., query 306, from the environment 301 via, e.g., the application interface 302 and model serving interface 304. The model input generator 314 converts the query 306 to a form that is ingestible by the trained neural network with attention 328, e.g., model input 326.

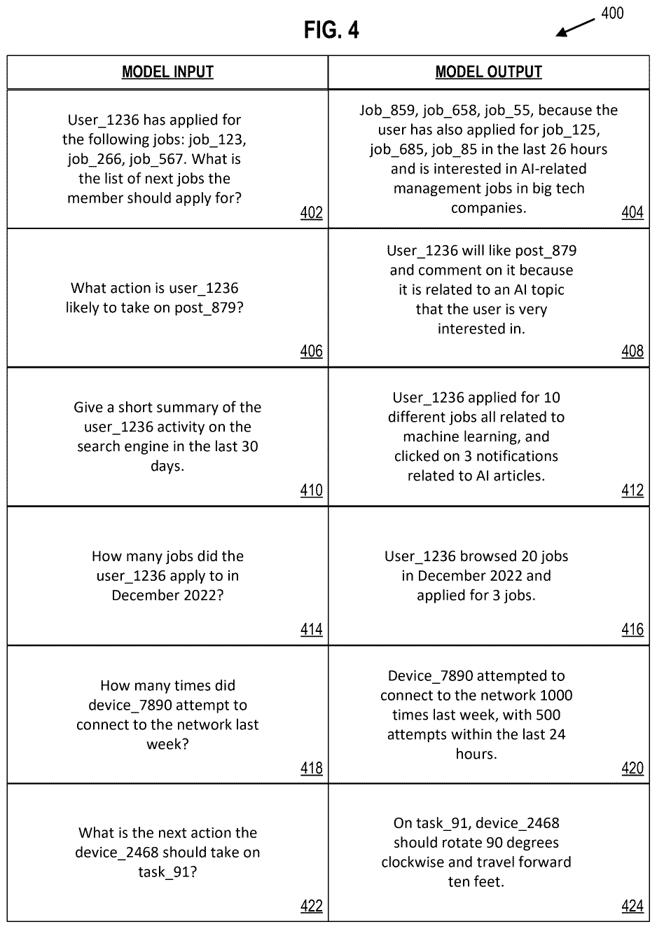

The query 306 includes an implicit or explicit request for a sequence prediction. In some examples, query 306 includes an entity ID and a first action sequence. In other examples, query 306 includes one or more entity IDs without explicitly identifying any action sequences. In still other examples, query 306 does not explicitly include any entity IDs. In examples where query 306 does not explicitly identify any entity IDs, one or more entity IDs associated with the query 306 may be obtained and appended to the query 306, e.g., using login session information maintained by application interface 302. Illustrative examples of queries that may be included in query 306 are shown in the first column of table 400 described with reference to FIG. 4.

To produce model input 326, model input generator 314 converts the query 306 to tokens, converts the tokens to embeddings, and uses the embeddings to formulate the model input 326. To convert the query 306 to tokens, model input generator 314 includes a first tokenizer 316 and a second tokenizer 320. The first tokenizer 316 has an associated first vocabulary 318. The second tokenizer 320 has an associated second vocabulary 322. In some examples, the first tokenizer 316, first vocabulary 318, second tokenizer 320, and second vocabulary 322 are the same as or similar to the first tokenizer 116, first vocabulary 118, second tokenizer 120, and second vocabulary 122, described with reference to FIG. 1.

In some examples, the first tokenizer 316 is a standardized tokenizer such as a SentencePiece tokenizer, with the first vocabulary 318 containing a standard vocabulary, such as the vocabulary provided with the SentencePiece tokenizer. The second tokenizer 320 is a non-standardized or customized tokenizer, with the second vocabulary 322 containing a non-standardized or customized vocabulary. In some examples, the second vocabulary 322 includes words that have a special meaning in the context of a particular domain or task, e.g., reserved words. Examples of reserved words include, in the job search context, “apply” and “job.” Other examples of reserved words include various types of entity identifiers, e.g., user_ID, job_ID, post_ID, device_ID, network_ID, etc.

During the tokenization portion of the action sequence prediction method 300, the first tokenizer 316 converts portions of the query 306 that do not correspond to reserved words of the second vocabulary 322 into content tokens 317 in accordance with the first vocabulary 318, and the second tokenizer 320 converts portions of the query 306 that correspond to reserved words into entity tokens 321 in accordance with the second vocabulary 322. The first tokenizer 316 outputs content tokens 317 for portions of the query 306 that are not tokenized by the second tokenizer 320. The second tokenizer 320 outputs entity tokens 321 for portions of the query 306 that are not tokenized by the first tokenizer 316.

The model input generator 314 converts the tokenized query, e.g., content tokens 317 and entity tokens 321, into respective embeddings, e.g., content embeddings 323 and entity embeddings 327, using an embedding table 324 and one or more embedding stores that store pre-trained embeddings, e.g., embeddings that have been generated during training of the trained neural network with attention 328 (e.g., via model training method 100 described with reference to FIG. 1). In some examples, the embedding stores include a content embedding store 512 for content that does not include entity identifiers or reserved words and entity embedding stores 514 for entity identifiers and other reserved words (e.g., one entity embedding store 514 for each different entity type). The embedding table 324 maps content tokens 317 to their respective content embeddings 323 stored in content embedding store 512 and maps entity tokens 321 to their respective entity embeddings 327 stored in the corresponding entity embedding store 514. In this way, the embedding table 324 is extended to include the mappings for the entity embeddings 327. The extension of the embedding table 324 to include the mappings for the entity-specific embeddings enables the entity-specific context associated with entity IDs included in the query 306 to be included in the model input 326 along with the respective entity IDs.

In the action sequence prediction method 300, the model input 326, including the content embeddings 323 and entity embeddings 327, as the case may be, is provided to the trained neural network with attention 328. The trained neural network with attention 328 includes a trained version of the neural network with attention 132 that has been trained as described with reference to FIG. 1 (e.g., via model training method 100). For instance, the trained neural network with attention 328 includes an RNN with attention, a CNN with attention, a sequence-to-sequence model, an encoder-decoder model, or a transformer model. Examples architectures of trained neural network with attention 328 are described with reference to FIG. 5 and FIG. 6.

Trained neural network with attention 328 processes the model input 326 and generates model output 334 in response to the model input 326. Examples of model outputs that may be generated by trained neural network with attention 328 in response to respective inputs are shown in the second column of table 400 described with reference to FIG. 4.

The trained neural network with attention 328 is capable of producing output that reflects relationships between different entity IDs and relationships between positions of reserved words and specific entity IDs (e.g., relative positions) that have been machine learned by the trained neural network with attention 328, e.g., via model training method 100. Also as a result of such training, the trained neural network with attention 328 is capable of generating predictive output that is customized for an entity ID contained in the model input 326 (e.g., via the trained, entity-specific set of one or more model parameters in the trained model).

For instance, given first model input that includes a first query and a first entity identifier, the trained neural network with attention 328 produces first model output that is specific to the entity identified by the first entity identifier (e.g., reflects the entity's context). Given second model input that includes the same first query and a second entity identifier of the same entity type as but identifying a different entity than the first entity identifier, the trained neural network with attention 328 produces second model output specific to the second entity identifier, i.e., different from the first model output, even though the same query is used in both instances. This result is possible because the trained neural network with attention 328 uses the model parameters specific to the first entity identifier (but not the model parameters specific to the second entity identifier) to respond to the first model input and uses the model parameters specific to the second entity identifier (but not the model parameters specific to the first entity identifier) to respond to the second model input.

Model evaluator 330 evaluates model output 334 using one or more evaluation criteria. In some examples, model evaluator 330 applies one or more filters, classifiers, or signal detectors to the model output 334 to identify and exclude extraneous, inappropriate, or inaccurate content from the output 334 (e.g., spam filters, AI hallucination detectors, validation models, etc.).

Model evaluator 330 includes a decision block 332. In response to determining that the model output 334 meets or exceeds threshold values for the one or more evaluation criteria, the model evaluator 330 provides the model output 334 to model serving interface 340, and model serving interface 340 provides the model output 334 to application interface 302. In response to determining that the model output 334 does not meet or exceed the threshold values for the one or more evaluation criteria, the model evaluator 330 provides an error signal 336 to model serving interface 340 alone or in combination with the model output 334. In response to the error signal 336, the model serving interface 340 provides the model output 334 to application interface 302 along with information from the error signal 336 (e.g., with qualifications or disclaimers), in some examples. In other examples, the model serving interface 340 provides a request for additional information to application interface 302, in response to the error signal 336. The evaluation criteria, threshold values, and responses to error signals are each configurable in accordance with the requirements or design of the action sequence prediction system 303.

The model serving interface 340 includes or is connected to, e.g., a hosted platform such as AI model service 990 described with reference to FIG. 9. Model serving interface 340 makes trained versions of the neural network model with attention 328 accessible by one or more components of the environment 301. In some examples, model serving interface 340 provides a library of API calls that are usable by one or more other devices, networks, models, systems, etc., to communicate with the trained version of the neural network model with attention 328. In some examples, model serving interface 340 is or includes model serving interface 304 but is shown separately in FIG. 3 for ease of illustration.

In some examples, the output provided by the model serving interface 340 via application interface 102 to the environment 301 includes digital content for presentation via a graphical or multimodal user interface at one or more user devices 301A (e.g., search results, recommendations, access control instructions, user interface elements), control signals for processing by one or more components of the network 301B (e.g., network traffic routing instructions, load balancing instructions, network security instructions), or control signals for processing by one or more components of the sensing devices 301C (e.g., navigation instructions for a robotic device or vehicle, articulation or manipulation instructions for a component of a robotic device or vehicle, or operational instructions for a robotic device or vehicle, such as instructions to start, stop, or temporarily suspend the deployment of a component of the device or vehicle).

The examples shown in FIG. 3 and the accompanying description are provided for illustration purposes. This disclosure is not limited to the described examples.

FIG. 4 is a table showing examples of input and output of a neural network in accordance with some examples of the present disclosure.

In FIG. 4, the first column of table 400 includes examples of model input, e.g., queries that may be input to a trained neural network with attention such as trained neural network with attention 328. The second column of table 400 incudes examples of model output, e.g., output that may be produced by the trained neural network with attention, e.g., trained neural network with attention 328, in response to the input shown in the first column of the correspond row.

In a first example, the model input 402 includes specific entity IDs (user_1236, job_123, job_266, job_567, and reserved words (e.g., “applied”, “apply”). In response to the model input 402, the trained neural network with attention as described herein produces model output 404. In producing the model output 404, the trained neural network with attention recognizes user_1236 as a unique entity identifier of a specific entity type (user), recognizes that “applied” and “apply” are to be interpreted in the context of job searching, recognizes that “applied” connects the user ID (user_1236) with the job IDs (job_123, job_266, job_567) to form a first action sequence (e.g., historical action sequence including user_1236 applied to job_123, user_1236 applied to job_266, user_1236 applied to job_567).

In response to the model input 402, the trained neural network with attention predicts a second action sequence (e.g., user_1236 should apply to job_859, job_658, and job_55). The model output 404 also indicates applicable aspects of the user_1236's context, such as another historical action sequence (user also applied to job_125, job_685, job_85 in the last 26 hours) and information from the user's online profile or query history (e.g., user is interested in AI related management jobs in big tech companies), which may be obtained via the entity embedding for the user. The reference to jobs the user applied for within the last 26 hours indicates that API augmentation may have been used to ensure that the model input to the trained neural network with attention included the most recent interaction data. The first example also illustrates how the neural network with attention trained as described is able to weight the job IDs appropriately even though they occur in the middle portion of the model input 402.

In a second example, the model input 406 includes a specific pair of entity IDs (user_1236 and post_879), does not specify a historical action sequence, and requests a prediction of the next action the user_1236 is likely to take on the post_879. In producing the model output 408, the trained neural network with attention recognizes user_1236 as a unique entity ID of a specific entity type (user), recognizes post_879 as a unique entity identifier of a different entity type (post), and recognizes that “action” connects the user ID with the post ID. The model output 408 includes a predicted next action involving the two entity IDs included in the input 406, and includes a portion of the user's context obtained via the entity embedding, facilitated by the entity embedding table.

In a third example, the model input 410 includes the user ID (user_1236) and requests a summary of activity on a specific application (search engine) within a specific time period (last 30 days). In producing the model output 412, the trained neural network with attention identifies and summarizes the requested portion of the user's historical action sequence (e.g., action sequence 106 described with reference to FIG. 1). The model output 412 includes the user ID as an indication that the output includes only information from the activity history associated with that specific entity identifier.

In a fourth example, the model input 414 includes the user ID (user_1236) and the reserved word “apply.” The model input 414 requests a count of the number of jobs the user applied to in a certain month (December 2022). In response to the model input 414, the trained neural network with attention is able to generate the requested count and distinguish between browed jobs and jobs that the user applied for.

The fourth example helps illustrate that, unlike other machine learning models, the process for training the neural network with attention does not require pre-computed features such as aggregations like counts, averages, etc. Instead, the trained neural network with attention is capable of computing such aggregations, given the training using historical action sequences and graph connections.

The fifth and sixth examples help illustrate how the trained neural network model is operable across multiple different tasks and domains. In the fifth example, the model input 418 includes a device identifier (device_7890) and requests a count of network connection activity. In response to the model input 418, the trained neural network model is able to identify “the network” via the action history associated with the device ID and determine the requested count. The trained neural network model may use API augmentation to obtain the most recent portion of the device's connection history (e.g., 500 attempts within the last 24 hours).

In the sixth example, the model input 422 includes a pair of unique entity IDs (e.g., device_2468 and task_91) and requests a predicted next action. In response to the model input 422, the trained neural network with attention recognizes that the word “action” connects the device ID and the task ID. As a result, the model output 424 includes a predicted next action that is specific to the device and task identified in the model input 422, and the model output 424 includes the associated entity identifiers.

The examples shown in FIG. 4 and the accompanying description are provided for illustration purposes. This disclosure is not limited to the described examples.

FIG. 5 is a block diagram of an example neural network in accordance with some examples of the present disclosure. In some examples, portions of the neural network of FIG. 5 are included in one or more computing system components shown in FIG. 1, FIG. 2, FIG. 3, FIG. 6, FIG. 7, computing system 900 of FIG. 9, or computer system 1000 of FIG. 10.

In FIG. 5, a neural network with attention 500 is embodied in one or more non-transitory computer-readable media, e.g., memory. The neural network with attention 500 includes an encoder with attention 502, a decoder with attention 504, entity embedding tables 506, 508, embedding stores 510, and a disabled or omitted position encoder 524. The input to the encoder with attention 502 is operably coupled to the position encoder (disabled or omitted) 524, entity embedding table 506, and an input layer of the neural network indicated by arrows 542. The output of the encoder with attention 502 is operably coupled to input of the decoder with attention 504. The decoder with attention 504 is operably coupled to position encoder (disabled or omitted) 524, entity embedding table 508, and an output layer 540 of the neural network with attention 500 indicated by arrows.

The encoder with attention 502 is a functional component of the neural network with attention 500 that converts variable-length input sequences into fixed-length representations of the variable-length input. The encoder with attention 502 includes an attention mechanism. Through training as described, the attention mechanism adjusts weight values on connections between portions of the model input. In some examples, the attention mechanism assigns higher weight values to relationships between entity identifiers or relationships between entity identifiers and reserved words, and lower weight values to relationships to relationships between non-reserved words or between entity identifiers and non-reserved words. The attention mechanism adjusts weight values independently or irrespective of the absolute position of the words, e.g., the relative position of words in the input with respect to each other is weighted more highly than the absolute position of the words with respect to the input as a whole (e.g., relative to the beginning and end of the input). These aspects of the attention mechanism are indicated by the relationship graph 526, described in more detail below.

The decoder with attention 504 is a functional component of the neural network with attention 500 that generates an output sequence from the encoder output (e.g., the fixed-length representations of the variable-length input produced by the encoder with attention 502. The decoder with attention 504 includes an attention mechanism. Through training as described, the attention mechanism adjusts weight values on connections between portions of the decoder input (e.g., the encoder output). In some examples, the attention mechanism assigns higher weight values to relationships between entity identifiers or relationships between entity identifiers and reserved words, and lower weight values to relationships to relationships between non-reserved words or between entity identifiers and non-reserved words. The attention mechanism adjusts weight values independently or irrespective of the absolute position of the words, e.g., the relative position of words in the decoder input with respect to each other is weighted more highly than the absolute position of the words with respect to the input as a whole (e.g., relative to the beginning and end of the input). These aspects of the attention mechanism are indicated by the relationship graph 528, described in more detail below.

The entity embedding table 506 maps model input containing entity identifiers or other reserved words to associated embeddings, which are retrieved from the embedding stores 510. The entity embedding table 508 maps decoder input containing entity identifiers or other reserved words to associated embeddings, which are retrieved from the embedding stores 510.

The embedding stores 510 include a content embedding store 512 and one or more entity embedding stores 514. The content embedding store 512 stores pre-trained embeddings for tokens that do not contain reserved words or entity identifiers (e.g., content tokens). The one or more entity embedding stores 514 store pre-trained embeddings associated with reserved words and entity identifiers for tokens that contain reserved words or entity identifiers (e.g., entity tokens). The one or more embedding stores 514 include a different embedding store for each different entity type, in some examples.

FIG. 5 illustrates an example operation of the neural network with attention 500. In the example operation, the neural network with attention 500 receives activity input from up to N different tasks, where N is a positive integer. In the illustrated example, a model input 516 includes the sequence “U123 has applied for jobs J133, J256, what next?” As shown in FIG. 5, the model input 516 has a beginning token 530, an ending token 532, and a sequence of tokens between the beginning token 530 and the ending token 532. The model input 516 includes a reserved word 534 (“applied”) and entity identifiers 536, 538 (J133, J256).

The entity embedding table 506 maps the reserved word 534 and each of the entity identifiers 536, 538 to the corresponding entity embeddings obtained via entity embedding store 514 (e.g., “applied” maps to embedding EE11, identifier J133 maps to embedding EEJ133, identifier J256 maps to embedding J256). The tokens that are not entity identifiers or reserved words are mapped to corresponding content embeddings via content embedding store 512. As a result of the mappings provided by the entity embedding table 506, the specialized embeddings associated with the reserved words and entity identifiers are incorporated into the model input. Without the entity embedding table 506, the reserved words would likely be mapped to imprecise content embeddings and the entity identifiers likely would be flagged as unrecognized.

In some neural network models, such as LLMs, disabling the position encoder is non-intuitive because commonly, positional encodings are integral to the model's ability to understand the order of tokens in a sequence and therefore understand the model input. Disabling the position encoder 524 enables the encoder with attention 502 to disregard any absolute position information that may be contained in the model input or to prevent the position encoder 524 from adding absolute position information to the model input. Disabling the position encoder 524 also enables the decoder with attention 504 to disregard any absolute position information that may be contained in the encoder output or to prevent the position encoder 524 from adding absolute position information to the encoder output.

Disabling the position encoder 524 may involve altering the model's architecture to exclude positional encodings. In some examples, position encoder 524 is modified or bypassed by using a type of embedding that does not rely on positional information. In some examples, the position encoder 524 is disabled or omitted by zeroing out any positional encodings that the position encoder 524 would otherwise apply to the model input (e.g., by setting positional encoding vectors to zero so that they have no effect on the model output). In some examples, training the model without positional encodings is sufficient to disable or omit the position encoder 524. In some examples, disabling the position encoder 524 may involve adjusting the value of a hyperparameter and/or modifying programming code.

In the encoder with attention 502, the attention mechanism of the encoder assigns weights to the different portions of the input so that the weight values indicate the importance of the relationships between the user ID (U123) and the jobs that the user has applied for (J133 and J256), as indicated by graph 526.

In response to the encoder output, the decoder with attention 504 generates predicted next jobs 520, which are predicted specifically for the user U123 (e.g., given the context provided by the entity embeddings associated with U123, J133, and J256). The entity embedding table 508 maps the predicted next jobs 520 (J45, J67) to associated entity embeddings and the attention mechanism of the decoder assigns weights to the different portions of the predicted next actions so that the weight values retain the relationship between the user ID (U123) and the predicted next actions (J45, J67), as indicated by graph 528. The decoder outputs the predicted next actions 522 and output layer 540 provides the predicted next actions 522 to the N requesting tasks.

The examples shown in FIG. 5 and the accompanying description are provided for illustration purposes. This disclosure is not limited to the described examples.

FIG. 6 is a block diagram of an example neural network in accordance with some examples of the present disclosure. In some examples, portions of the neural network of FIG. 6 are included in one or more computing system components shown in FIG. 1, FIG. 2, FIG. 3, FIG. 5, FIG. 7, computing system 900 of FIG. 9, or computer system 1000 of FIG. 10.

In FIG. 6, a neural network with attention 600 is embodied in one or more non-transitory computer-readable media, e.g., memory. The neural network with attention 600 includes a transformer model 642 and an extension 602, where the extension 602 includes an embedding table 606, content embedding store 616, entity embedding store 618, and a disabled or omitted position encoder 610.

A transformer model is a deep neural network encoder-decoder model that uses a computer-implemented function called attention or self-attention to detect relationships and dependencies among data elements in a sequence. The attention mechanism facilitates the detection of relationships and dependencies between words, phrases, or tokens in a model input by enabling the model to assign different weights, e.g., attention weights, to different portions of the model input based on the detected relationships and dependencies.

There are different kinds of attention mechanisms. A self-attention mechanism is a type of attention mechanism that enables a machine learning model to determine the context of each word or token in relation to every other word or token in a model input, thereby capturing dependencies and relationships between words or tokens across the model input. A multi-head attention mechanism is a type of self-attention mechanism that enhances the model's ability to process input sequence because it contains multiple attention heads instead of a single attention head. Instead of relying on a single attention head, which computes weighted sums of portions of the model input based on their relationships to specific context, multi-head attention employs multiple attention heads simultaneously, where each of the attention heads processes different portions of the model input in parallel. The outputs of the multiple attention heads are combined to provide a more complex interpretation of the model input that may improve the model's performance across various tasks.

A masked multi-head attention mechanism applies masking to certain attention weights to prevent the model from attending to subsequent tokens. Masking may be done by setting the weights of the masked positions in the input to, e.g., a very large negative value. The masked multi-head attention mechanism is used in decoders to ensure sequential processing of tokens.

FIG. 6 illustrates a transformer-based architecture that includes self-attention layers, feed-forward layers, and residual connections between the layers. The exact number and arrangement of layers of each type as well as the hyperparameter values used to configure the model are variable based on the requirements of a particular design or implementation.

In the example of FIG. 6, the transformer model 642 is constructed using a neural network-based machine learning model architecture including an encoder 644 and a decoder 654. The encoder 644 and decoder 654 each include one or more attention mechanisms. The encoder 644 includes a multi-head attention layer 645. The decoder 654 includes a masked multi-head attention layer 655 and a multi-head attention layer 657.

In the transformer model 642, feed-forward layers (e.g., feed-forward layer 647 and feed-forward layer 659) follow the attention mechanisms in both the encoder 644 and the decoder 654. In the context of transformer models, feed-forward layers are sub-units within the encoder and decoder, respectively. A feed-forward layer itself includes a fully-connected neural network that applies a transformation (e.g., a non-linear transformation) to the output of an attention mechanism. The transformation applied by the feed-forward layer may enable the model to determine more complex patterns within the data to improve the model output.

In the transformer model 642, a residual connection (e.g., add & norm layer 646, add & norm layer 648, add & norm layer 656, add & norm layer 658, add & norm layer 660) follows each of the attention mechanisms and feed-forward layers, respectively. In the context of transformer models, residual connections are used to ensure that original input information is retained and integrated with transformed outputs produced by the respective attention mechanisms and feed-forward layers, and to potentially speed up the model training process using normalization.

In operation, transformer model 642 feeds respective input and output portions of embedded subsequences 650 into encoder 644 and decoder 654, respectively. For example, transformer model 642 feeds inputs of embedded subsequences 650 into multi-head attention layer 645 of encoder 644 and feeds outputs of embedded subsequences 650 into masked multi-head attention layer 655 of decoder 654.

In the example of FIG. 6, the input and output portions of embedded subsequences 650 are respectively generated using the extension 602, e.g., embedding table 606, disabled or omitted position encoder 610, content embedding store 616, and entity embedding store 618. In some examples, the inputs 604 include tokens produced by first and second tokenizers (e.g., a general-purpose or standardized content tokenizer and a special-purpose or non-standardized entity tokenizer) as described herein. The inputs 604 are mapped to input embeddings 608 using embedding table 606, where the embedding table 606 includes mappings from entity tokens to corresponding entity embeddings as described herein. Via the embedding table 606, content embeddings and entity embeddings for respective portions of the inputs 604 are obtained using content embedding store 616 and one or more entity embedding stores 618. The resulting combination of content embeddings and entity embeddings, e.g., input embedding 608, pass through the disabled or omitted position encoder 610 (or are processed by disabled or omitted position encoder 610 to remove or prevent the addition of absolute position information to the embeddings) and are provided to encoder 644 as input embedded subsequences 650.

During model training, a training instance includes inputs 604 and associated outputs 612. After model training, e.g., at inference time, only inputs 604 are provided to the model. During training, using the extension 602, the outputs 612 include tokens produced by first and second tokenizers (e.g., a general-purpose or standardized content tokenizer and a special-purpose or non-standardized entity tokenizer) as described herein. The outputs 612 are mapped to output embeddings 614 using embedding table 606, where the embedding table 606 provides mappings from entity tokens to corresponding entity embeddings as described herein. Via the embedding table 606, content embeddings and entity embeddings for respective portions of the outputs 612 are obtained using content embedding store 616 and one or more entity embedding stores 618. The resulting combination of content embeddings and entity embeddings, e.g., output embeddings 614, pass through the disabled or omitted position encoder 610 (or are processed by disabled or omitted position encoder 610 to remove or prevent the addition of absolute position information to the embeddings) and are provided to encoder 644 as output embedded subsequences 650.

As shown in FIG. 6, encoder 644 includes multi-head attention layer 645, add & norm layer 646, feed-forward layer 647, and add & norm layer 648. Multi-head attention layer 645 receives inputs of embedded subsequences 650 and computes output representations for the inputs of embedded subsequences 650. In some examples, multi-head attention layer 645 converts inputs of embedded subsequences 650 into queries, keys, and values using query, key, and value matrices. Multi-head attention layer 645 computes the output representation of the inputs of embedded subsequences 650 as a weighted sum of the values of all of the inputs of embedded subsequences 650. Multi-head attention layer 645 computes the weights for the weighted sum by applying a compatibility function to the corresponding key and query for the value. In some examples, multi-head attention layer 645 uses a scaled dot product on the key and query of an input of embedded subsequences 650 to determine a weight to apply to a value of the input. Multi-head attention layer 645 includes multiple attention blocks which each compute an output representation for the inputs of embedded subsequences. Multi-head attention layer 645 aggregates the output representations of these attention blocks to generate a final output representation for multi-head attention layer 645.

Transformer model 642 feeds the output representation generated by multi-head attention layer 645 and residual connections from the inputs of embedded subsequences 650 into add & norm layer 646. The residual connections prevent the transformer model 642 from “forgetting” features of embedded subsequences 650 during training. Forgetting in the context of machine learning means that as the model continues to be sequentially trained on different datasets, the model continually adjusts the values of feature coefficients based on the most recent datasets, thereby potentially losing or diluting the effect on those coefficient values of the datasets used earlier in training.

In some examples, add & norm layer 646 sums the output representation generated by multi-head attention layer 645 and the residual connections from inputs of embedded subsequences 650 and applies a layer normalization to the result. In some examples, the add & normal layers apply a SoftMax function to generate action probabilities for the inputs of embedded subsequences 650. In some examples, add & norm layer 646 generates estimated probabilities \hat{p}(aₖ|s), where aₖ is the action policy and s is the state features.

Transformer model 642 feeds the normalized output of add & norm layer 646 into feed-forward layer 647. Feed-forward layer 647 is a feed-forward network that receives and passes the normalized output of add & norm layer 646, through the hidden layers of feed-forward layer 647, and feeds the output of feed-forward layer 647 to add & norm layer 648. Feed-forward layer 647 processes the information received from add & norm layer 646 and updates the hidden layers of feed-forward layer 647 based on the information (e.g., during training) and/or generates an output based on the hidden layers processing the information (e.g., during evaluation and/or inference). In some examples, during training, transformer model 642 updates the weights of the hidden layers of feed-forward layer 647 based on the inputs and the loss of the transformer system. In other examples, during evaluation and/or inference, the weights of the hidden layers of feed-forward layer 647 are used to determine the output representation 652 of each of the inputs of embedded subsequences 650.

Transformer model 642 feeds the output of feed-forward layer 647 into add & norm layer 648 as well as residual connections from the output of add & norm layer 646. Add & norm layer 648 sums the output of feed-forward layer 647 with the residual connections from add & norm layer 646 and applies a layer normalization to the result to generate output of the add & norm layer 648.

The output of the add & norm layer 648 is processed by extension 602 in a similar manner as described above, e.g., entity embeddings as described herein are included in the encoder output representation 652 via embedding table 606 and positional encoding is disabled or omitted in the generation of the encoder output representation 652. The application of extension 602 to the output of add & norm layer 648 produces the encoder output representation 652. Transformer model 642 feeds encoder output representation 652 into multi-head attention layer 657 of decoder 654.

During training, transformer model 642 feeds output representation 652 and outputs of embedded subsequences 650 into decoder 654. Decoder 654 generates a sequence of tokens based on encoder output representation 652 and the input embeddings 608. After training, e.g., at inference time, transformer model 642 feeds encoder output representation 652 into decoder 654, and decoder 654 generates a sequence of tokens based on encoder output representation 652 and the input embeddings 608.

During training, masked multi-head attention layer 655 receives outputs of embedded subsequences 650 and computes representations for the outputs of embedded subsequences 650 based on masked outputs of embedded subsequences 650. In some examples, masked multi-head attention layer 655 computes representations for each of the outputs of embedded subsequences 650 based on previous outputs while masking future (e.g., subsequent, in a sequence) outputs. Masked multi-head attention layer 655 computes representations using only outputs that come before (prior to, in a sequence) the output being predicted.

Transformer model 642 feeds the representation generated by masked multi-head attention layer 655 and residual connections from the outputs of embedded subsequences 650 into add & norm layer 656. Add & norm layer 656 sums the representation generated by masked multi-head attention layer 655 and the residual connections from outputs of embedded subsequences 650 and applies a layer normalization to the result.

Transformer model 642 feeds the normalized output of add & norm layer 656 into multi-head attention layer 657. Multi-head attention layer 657 receives the normalized output of add & norm layer 656 as well as encoder output representation 652 and generates a representation based on both the normalized output of add & norm layer 656 and encoder output representation 652.

Transformer model 642 feeds the representation generated by multi-head attention layer 657 and residual connections from the output of add & norm layer 656 into add & norm layer 658. Add & norm layer 658 sums the representation generated by multi-head attention layer 657 and the residual connections from the output of add & norm layer 656 and applies a layer normalization to the result.

Transformer model 642 feeds the normalized output of add & norm layer 658 into feed-forward layer 659. Feed-forward layer 659 is a feed-forward network that receives the normalized output of add & norm layer 658, feeds it through the hidden layers of feed-forward layer 659, and then feeds the output of feed-forward layer 659 into add & norm layer 659. Feed-forward layer 659 processes the information received from add & norm layer 658 and updates the hidden layers of feed-forward layer 659 based on the information (e.g., during training) and/or generate an output based on the hidden layers processing the information (e.g., during evaluation and/or inference). In some examples, during training, transformer model 642 updates the weights of the hidden layers of feed-forward layer 659 based on the inputs and the loss of the transformer system. In other examples, during evaluation and/or inference, the weights of the hidden layers of feed-forward layer 659 are used to determine the output of feed-forward layer 659.

Transformer model 642 feeds the output of feed-forward layer 659 into add & norm layer 660 as well as residual connections from the output of add & norm layer 658. Add & norm layer 660 sums the output of feed-forward layer 659 with the residual connections from add & norm layer 658 and applies a layer normalization to the result to generate an output.

Transformer model 642 generates output probabilities 666 from the output of add & norm layer 660. In some examples, transformer model 642 applies a linear transformation 662 and a SoftMax function 664 to the output of add & norm layer 660 to generate a normalized vector of output probabilities 666. In other examples, the output of add & norm layer 660 is provided to, e.g., another model, system, process, or device.

In some examples, such as during training, transformer model 642 determines a loss based on output probabilities 666. In some examples, transformer model 642 uses deep quantile regression for training. In some examples, output probabilities 666 includes a mean prediction probability and estimations for the upper and lower bounds of the range of prediction such that output probabilities 626 includes an uncertainty range.

In some examples, the loss function of transformer model 642 using deep quantile regression is represented by the following equation:

$$ℒ ( {ξ}_{i} \vert α ) = \{ \begin{matrix}{αξ}_{i} & if {ξ}_{i} \geq 0 , \\ ( α - 1 ) {ξ}_{i} & if {ξ}_{i} < 0\end{matrix} ,$$

where α is the required quantile (a value between 0 and 1 representing the desired quantile) and ξᵢ=yᵢ−f(xᵢ), where f(xᵢ) is the mean predicted by output probabilities 666, yᵢ are the outputs of embedded subsequences 650 and xᵢ are the inputs of embedded subsequences 650. The loss over the entirety of a dataset of embedded subsequences 650 where embedded subsequences 650 has a length of N and N is a positive integer. In some examples, the loss is represented by the following equation:

$$ℒ ( y , f \vert α ) = \frac{1}{N} {\sum }_{i = 1}^{N} ℒ ( {y}_{i} - f ( {x}_{i} ) \vert α ) .$$

In some examples, output probabilities 666 include: a mean prediction, a lower bound quantile, and an upper bound quantile. In some examples, transformer model 642 uses upper confidence bound or Thompson sampling. In some examples, transformer model 642 determines output probabilities based on the mean prediction, the lower bound quantile, and the upper bound quantile based on upper confidence bound and/or Thompson sampling.

In some examples, transformer model 642 is trained to optimize the model parameters with trajectory-specific normalizations using cross-entropy loss. For example, transformer model 642 uses a loss function represented by the following equation:

$$L ( θ ) = \frac{1}{{N}_{traj}} {\sum }_{i}^{{N}_{traj}} {\sum }_{t = 1}^{{T}_{i}} {w}_{i} {\sum }_{k} log ( \hat{p} ( {a}_{k}^{( it )} \vert {s}^{( it )} ) ) ,$$

where Nₜᵣₐⱼ is the trajectory count, wᵢ is the normalization weight, aₖ^{(it)} is the predicted action for the trajectory i at timestep t, and s^{(it)} is the state of the online system for the trajectory i at timestep t. In some examples, transformer model 642 uses trajectory-wise normalization. For example, the add & norm layers of transformer model 642 normalize the weights according to the following equation:

$${w}_{i} = \frac{1}{{T}_{i}} ,$$

where Tᵢ is the length of trajectory i. In some examples, transformer model 642 uses global normalization. For example, the add & norm layers of transformer model 642 normalize the weights according to the following equation: wᵢ=c, where c is a positive scalar. In some examples, the scalar c is predetermined.

In some examples, the neural network with attention described herein includes one or more language models, such as large language models and/or other generative models, which may be implemented using transformer models. In some examples, the neural network with attention described herein includes a generative model constructed using a neural network-based machine learning model architecture. In some examples, the neural network-based architecture includes one or more input layers that receive task descriptions (or prompts), generate one or more embeddings based on the task descriptions, and pass the one or more embeddings to one or more other layers of the neural network. In other examples, the one or more embeddings are generated based on the task description by a pre-processor, the embeddings are input to the generative model, and the generative model outputs digital content, e.g., natural language text or a combination of natural language text and non-text output, based on the embeddings.

In some examples, the neural network with attention described herein includes or is based on one or more generative transformer models, one or more generative pre-trained transformer (GPT) models, one or more bidirectional encoder representations from transformers (BERT) models, one or more large language models (LLMs), one or more XLNet models, and/or one or more other natural language processing (NL) models that significantly advance the state-of-the-art in various linguistic tasks such as machine translation, sentiment analysis, question answering and sentence similarity. In some examples, the neural network-based machine learning model architecture includes or is based on one or more predictive content neural models that is capable of receiving digital content input and generating one or more outputs based on processing the digital content with one or more neural network models. Examples of predictive neural models include, but are not limited to, Generative Pre-Trained Transformers (GPT), BERT, and/or Recurrent Neural Networks (RNNs). In some examples, one or more types of neural network-based machine learning model architecture includes or is based on one or more multimodal neural networks capable of outputting different modalities (e.g., text, image, sound, etc.) separately and/or in combination based on digital content input. Accordingly, in some examples, a multimodal neural network is capable of outputting digital content that includes a combination of two or more of text, images, video or sound.

In some examples, the neural network with attention described herein includes a generative language model capable of being trained on a large dataset of natural language or textual content. In some examples, training samples of natural language or textual content extracted from publicly available data sources are used to train the generative language model. The size and composition of the dataset used to train the generative language model is variable according to the requirements of a particular design or implementation. In some examples, the dataset used to train the generative language model includes hundreds of thousands to millions or more different natural language or textual training samples. In some examples, the generative language model includes multiple generative language models trained on differently sized datasets.

In some examples, model inputs to the neural network with attention described herein include or are in the form of prompts. Prompt engineering is a technique used to optimize the structure and/or content of a prompt input to a generative model. Some prompts include examples of outputs to be generated by the generative model (e.g., few-shot prompts), while other prompts include no examples of outputs to be generated by the generative model (e.g., zero-shot prompts). Chain of thought prompting is a prompt engineering technique where the prompt includes a request that the model explain reasoning in the output. For example, the generative model performs the task described in the prompt using a series of steps and outputs reasoning as to each step performed.

In some examples, the neural network with attention described herein is trained using supervised learning. Supervised learning is a method of training (or fine-tuning) a machine learning model given input-output pairs, where the output of the input-output pair is known (e.g., an expected output, a labeled output, a ground truth). Other training methods, including semi-supervised learning or federated learning, are used to train the neural network with attention described herein or to fine-tune the neural network with attention described herein, in some examples.

In some examples, the neural network with attention described herein includes a language model that is trained or fine-tuned by providing a series of prompts as input to the machine learning model. In some examples, a prompt includes natural language or textual instructions, queries, output examples, etc. The model generates output by applying the weights and nodes of the model to the prompt. In some examples, error is determined by comparing the model output to a reference or expected output. In some examples, the similarity between the model output and the expected output is evaluated using a similarity metric or model performance metric. The error is used to adjust the value of weights in a weight matrix included in the language model and/or the number of layers and/or arrangement of layers included in the model.

In some examples, the neural network with attention described herein is trained using a backpropagation algorithm. The backpropagation algorithm operates by propagating the error through each of the algorithmic weights of the model such that the algorithmic weights are adjusted based on the amount of error. In some examples, the error is calculated at each iteration, batch, and/or epoch. The error is computed using a loss function. An example loss function includes the cross-entropy error function. After a number of training iterations, the model converges, e.g., adjusts weight values over time until the model output achieves an acceptable level of accuracy or reliability (e.g., accuracy satisfies a defined tolerance or confidence level). The values of the weights of the trained model (e.g., after convergence) are stored to enable the trained machine learning model to be deployed during inference time.

In some examples, the neural network with attention described herein is configured and implemented as a network service. In some examples, the model is configured using a machine learning library and an application programming interface (API), e.g., via an API call such as ML_library.model(p1, p2, . . . pn), where p indicates a parameter or argument of the call, such as a model hyperparameter or an input identifier. In some examples, the model and/or its output is hosted on one or more servers and/or data storage devices for accessibility to one or more requesting processes, systems, devices, frameworks, or services.

The examples shown in FIG. 6 and the accompanying description, above are provided for illustration purposes. This disclosure is not limited to the described examples.

FIG. 7 is a component-based flow diagram of an example method for serving a neural network model in accordance with some examples of the present disclosure.

In FIG. 7, a method 700 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 700 is performed by the computing system components shown in FIG. 1, FIG. 3, FIG. 5, FIG. 6, FIG. 7, one or more components of sequence prediction system 980 of FIG. 9, or sequence prediction system 1050 of FIG. 10. Although shown in a particular sequence or order, unless otherwise specified, the order of the processes is modified, in some examples. Processes are performed in a different order, and some processes are performed in parallel, in some examples. Additionally, one or more processes are omitted in various examples. Thus, not all processes are required in every example. Other process flows are possible.

In FIG. 7, a computing system includes entity representation services 702, and foundation model 706. Entity representation services 702 includes components that generate entity representations, e.g., entity embeddings, using action sequences and/or connection graphs as described herein. In some examples, entity representation services 702 includes natural language or textual representation generator 110 and training input generator 114 described with reference to FIG. 1. In some examples, entity representation services 702 includes model input generator 314 described with reference to FIG. 2.

Foundation model 706 includes a neural network with attention as described herein, such as neural network with attention 132 described with reference to FIG. 1, trained neural network with attention 328 described with reference to FIG. 3, neural network with attention 500 described with reference to FIG. 5, or neural network with attention 600 described with reference to FIG. 6.

In some examples, foundation model 706 is trained on entity-specific action sequences and/or connection graphs for a large number of entities, e.g., millions or hundreds of millions of entities, e.g., users of an application system, devices on a network, etc. Alternatively or in addition, in some examples, foundation model 706 is trained using training data for multiple different tasks such that the foundation model 706 is usable to generate predictive output for a wide variety of tasks (e.g., job search, feed ranking, notifications; network security, device control, fraud detection, such as detection of fraudulent user accounts, etc.).

The computing system of FIG. 7 includes optional components, e.g., API augmentation services 704, distillation/compression services 708, and downstream model 710. The API augmentation services 704 are usable to ensure freshness of training data used to train foundation model 706, e.g., by embedding API calls in training input as described herein.

The distillation/compression services 708 are usable to create smaller, customized models, e.g., downstream model 710, using foundation model 706 or to improve the zero-shot or few-shot capabilities of the foundation model 706. In some examples, distillation/compression services 708 apply one or more chain-of-thought-based distillation, privilege features, compression techniques such as quantization, and/or pruning techniques to foundation model 706 to create one or more downstream models 710. In chain-of-thought distillation, the foundation model 706 acts as a teacher model to the downstream model 710 to not only to generate predictive output but also to replication the logical steps performed to produce the predictive output.

In some examples privilege features enable the teacher or foundation model 706 to identify highly informative but runtime-expensive information and transform that information to the student or downstream model 710. These and/or other distillation techniques are combined with one or more compression techniques, such as quantization techniques, in some examples, and/or with efficient transformer techniques, to reduce the size of the downstream model 710, thereby improving its serving metrics, e.g., queries per second (QPS) and latency.

In some examples, access to the foundation model 706 is provided by a model serving interface, such as model serving interface 140 described with reference to FIG. 1 or model serving interface 304, 340 described with reference to FIG. 3. In some examples, the one or more downstream models 710 are accessible via a model serving interface (e.g., foundation model 706 is maintained offline). In some examples, entity representation services 702 and/or API augmentation services 704 are accessible via a model serving interface.

The examples shown in FIG. 7 and the accompanying description are provided for illustration purposes. This disclosure is not limited to the described examples.

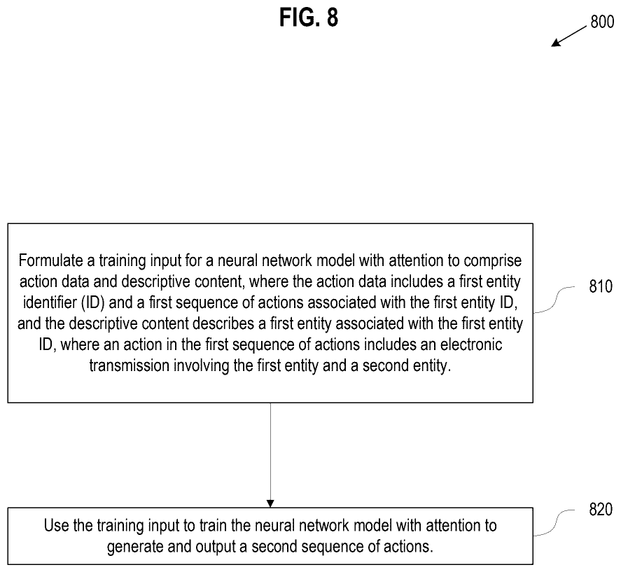

FIG. 8 is a flow diagrams of an example method for action sequence prediction using a neural network in accordance with some examples of the present disclosure.

In FIG. 8, a method 800 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 800 is performed by the computing system components shown in FIG. 1, FIG. 3, FIG. 5, FIG. 6, FIG. 7, one or more components of sequence prediction system 980 of FIG. 9, or sequence prediction system 1050 of FIG. 10. Although shown in a particular sequence or order, unless otherwise specified, the order of the processes is modified, in some examples. Processes are performed in a different order, and some processes are performed in parallel, in some examples. Additionally, one or more processes are omitted in various examples. Thus, not all processes are required in every example. Other process flows are possible.

At operation 810, the processing device formulates a training input for a neural network model with attention to include action data and descriptive content. The action data includes a first entity identifier (ID) and a first sequence of actions associated with the first entity ID. The descriptive content describes a first entity associated with the first entity ID. In some examples, an action in the first sequence of actions includes an electronic transmission involving the first entity and a second entity. Some examples of formulating training input are described with reference to FIG. 1. Some examples of neural network models with attention are described with reference to FIG. 5, FIG. 6, and FIG. 7.

At operation 820, the processing device uses the training input formulated at operation 810 to train the neural network model with attention to generate and output a second sequence of actions. In some examples, the entity identifier is included in the training input used to train the neural network model with attention. In some examples, a non-standardized tokenizer and the entity identifier are used to formulate the training input. In some examples, recommended actions such as actions included in a second sequence of actions, include actions a user is likely to take and/or actions that the user likely would not have thought to take otherwise. Some examples of sequences of actions (or action sequences) are described with reference to FIG. 1, FIG. 4 and FIG. 5.

In some examples of the method 800, the processing device determines that the action data includes a reserved word and using the non-standardized tokenizer to convert the reserved word to a token that describes the reserved word in the first sequence of actions, where the non-standardized tokenizer uses a non-standardized vocabulary to determine and output a word-based token for the reserved word.

In some examples of the method 800, formulating the training input includes using the non-standardized tokenizer to determine and output a word-based token for the first entity identifier. In some examples of the method 800, formulating the training input includes using a standardized tokenizer to convert the descriptive content to tokens that describe the first entity, where the standardized tokenizer uses a first vocabulary different from the non-standardized vocabulary to determine and output sub word-based tokens for the descriptive content.

In some examples of the method 800, formulating the training input includes including word-based tokens for actions in the first sequence of actions, the word-based token for the first entity ID, and the sub word-based tokens for the descriptive content in the training input. In some examples of the method 800, the action data includes a natural language textual representation of a graph, and the method further includes generating a natural language textual representation of the graph.

In some examples of the method 800, the action data includes a natural language textual representation of a data set and the method further includes generating the natural language textual representation of the data set.

In some examples of the method 800, an action in the action data includes a natural language textual representation of an application programming interface (API) call and the method further includes generating the natural language textual representation of the API call.

In some examples of the method 800, an action in the action data includes a spatial position related to a length of the action data and a temporal position related to a time of occurrence of the action, and the method further includes generating a representation of the action that excludes the spatial position.

In some examples of the method 800, the processing device logs the first sequence of actions during a session comprising a user operating an application; receives, from the first entity, a response to the second sequence of actions; and supplements the first sequence of actions by executing the second sequence of actions.

In some examples of the method 800, the first sequence of actions includes a query and the second sequence of actions is generated and output by the neural network model with attention in response to the query and the first sequence of actions.

In some examples of the method 800, the query includes a second entity ID associated with a second entity, and the second sequence of actions is generated and output by the neural network model with attention using the first entity ID and the second entity ID.

In some examples of the method 800, the query includes a request for a summary of actions of the first entity, and the second sequence of actions generated and output by the neural network model includes the summary of actions of the first entity.

In some examples of the method 800, the query includes the first entity ID and a second entity ID, and the second sequence of actions generated and output by the neural network model includes an action on an entity associated with the second entity ID.

In some examples of the method 800, the query includes a first list of entity IDs and the second sequence of actions generated and output by the neural network model with attention includes a second list of entity IDs.

The example shown in FIG. 8 and the accompanying descriptions, above are provided for illustration purposes. This disclosure is not limited to the described examples.

FIG. 9 is a block diagram of a computing system that includes a sequence prediction system in accordance with some examples of the present disclosure.

In the example of FIG. 9, a computing system 900 includes one or more user systems 910, a network 920, an application system 930, data resources and tools 950, a sequence prediction system 980, a data storage system 960, an event logging service 970, and an AI model service 990.

All or at least some components of sequence prediction system 980 are implemented at the user system 910, in some examples. In some examples, portions of sequence prediction system 980 are implemented directly upon a single client device such that communications involving applications running on user system 910 and sequence prediction system 980 occur on-device without the need to communicate with, e.g., one or more servers, over the Internet. Dashed lines are used in FIG. 9 to indicate that all or portions of sequence prediction system 980 are implemented directly on the user system 910, e.g., the user's client device, in some examples. In other words, both user system 910 and sequence prediction system 980 are implemented on the same computing device, in some examples. In other examples, all or portions of sequence prediction system 980 are implemented on one or more servers and in communication with user systems 910 via network 920.

A user system 910 includes at least one computing device, such as a personal computing device, a server, a mobile computing device, a wearable electronic device, or a smart appliance, and at least one software application that the at least one computing device is capable of executing, such as an operating system or a front end of an online system. In some examples, many different user systems 910 are connected to network 920 at the same time or at different times. In some examples, different user systems 910 contain similar components as described in connection with the user system 910. In some examples, many different end users of computing system 900 are interacting with many different instances of application system 930 through their respective user systems 910, at the same time or at different times.

User system 910 includes a user interface 912. User interface 912 is installed on user system 910 or accessible to user system 910 via network 920. In some examples, user interface 912 includes a front end portion of an application software system.

User interface 912 includes, for example, a graphical display screen that includes graphical user interface elements such as at least one input box or other input mechanism and at least one slot. A slot as used herein refers to a space on a graphical display such as a web page or mobile device screen, into which output, e.g., digital content such as search results, feed items, chat boxes, or threads, is loaded for display to the user, in some examples. User interface 912 is configured with a scrollable arrangement of variable-length slots that simulates an online chat or instant messaging session and/or a scrollable arrangement of slots that contain content items or search results, in some examples. The locations and dimensions of a particular graphical user interface element on a screen are specified using, for example, a markup language such as HTML (Hypertext Markup Language). On a typical display screen, a graphical user interface element is defined by two-dimensional coordinates. In other examples, such as virtual reality or augmented reality implementations, a slot is defined using a three-dimensional coordinate system.

In some examples, user interface 912 is used to interact with the sequence prediction system 980 and/or one or more application systems 930. In some examples, user interface 912 enables the user of a user system 910 to interact with an application software system to create, edit, send, view, receive, process, and organize workflows, tasks, plans, search queries, search results, content items, news feeds, and/or portions of online dialogs. In some examples, user interface 912 enables the user to input requests (e.g., queries) for various different types of information, to initiate user interface events, and to view or otherwise perceive output such as data and/or digital content produced by, e.g., an application system 930, sequence prediction system 980, content distribution service 938 and/or search engine 940. In some examples, user interface 912 includes a graphical user interface (GUI), a conversational voice/speech interface, a virtual reality, augmented reality, or mixed reality interface, and/or a haptic interface. In some examples, user interface 912 includes a mechanism for entering search queries and/or selecting search criteria (e.g., facets, filters, etc.), selecting GUI user input control elements, and interacting with digital content such as search results, entity profiles, posts, articles, feeds, and online dialogs. Examples of user interface 912 include web browsers, command line interfaces, and mobile app front ends. In some examples, user interface 912 includes application programming interfaces (APIs).

Network 920 includes an electronic communications network. Network 920 is implemented on any medium or mechanism that provides for the exchange of digital data, signals, and/or instructions between the various components of computing system 900. Examples of network 920 include, without limitation, a Local Area Network (LAN), a Wide Area Network (WAN), an Ethernet network or the Internet, or at least one terrestrial, satellite or wireless link, or a combination of any number of different networks and/or communication links.

In some examples, application system 930 includes one or more online systems, such as systems that provide social network services, general-purpose search engines, specific-purpose search engines, messaging systems, content distribution platforms, e-commerce software, enterprise software, network security, fraud detection, device control, or any combination of any of the foregoing or other types of software applications. Application system 930 includes any type of application system that provides or enables the retrieval of and interactions with at least one form of digital content via user interface 912. In some examples, portions of sequence prediction system 980 are components of application system 930.

In some examples, application system 930 includes an entity graph 932 and/or knowledge graph 934, a connection network 936, a content distribution service 938, and/or a search engine 940. In some examples, application system 930 interacts with sequence prediction system 980 to control a network, or a physical machine or device, such as a sensor, a vehicle, or a robot.

In some examples, a front end portion of application system 930 operates in user system 910, for example as a plugin or widget in a graphical user interface of a web application, mobile software application, or as a web browser executing user interface 912. In some examples, a mobile app or a web browser of a user system 910 transmits a network communication such as an HTTP request over network 920 in response to user input that is received through a user interface provided by the web application, mobile app, or web browser, such as user interface 912. A server running application system 930 receives the input from the web application, mobile app, or browser executing user interface 912, perform at least one operation using the input, and return output to the user interface 912 using a network communication such as an HTTP response, which the web application, mobile app, or browser receives and processes at the user system 910.

In the example of FIG. 9, application system 930 includes an entity graph 932 and/or a knowledge graph 934. Entity graph 932 and/or knowledge graph 934 includes data organized according to graph-based data structures that can be traversed via queries and/or indexes to determine relationships between entities. In some examples, entity graph 932 and/or knowledge graph 934 is used to compute various types of relationship weights, affinity scores, similarity measurements, and/or statistics between, among, or relating to entities.

Entity graph 932, knowledge graph 934 includes a graph-based representation of data stored in data storage system 960, described herein. For example, entity graph 932, knowledge graph 934 represents entities, such as users, organizations (e.g., companies, schools, institutions), content items (e.g., job postings, announcements, articles, comments, and shares), and computing resources (e.g., databases, models, applications, and services), as nodes of a graph. Entity graph 932, knowledge graph 934 represents relationships, also referred to as mappings or links, between or among entities as edges, or combinations of edges, between the nodes of the graph. In some examples, mappings between different pieces of data used by an application system 930 are represented by one or more entity graphs. In some examples, the edges, mappings, or links indicate relationships, online interactions, or activities relating to the entities connected by the edges, mappings, or links. In some examples, if a user clicks on a search result, an edge is created connecting the user entity with the search result entity in the entity graph, where the edge is tagged with a label such as “viewed.” In some examples, if a user viewing a list of search results skips over a search result without clicking on the search result, an edge is not created between the user entity and the search result entity in the entity graph.

In some examples, portions of entity graph 932, knowledge graph 934 are automatically re-generated or updated from time to time based on changes and updates to the stored data, e.g., updates to entity data and/or activity data. In some examples, entity graph 932 and/or knowledge graph 934 refers to an entire system-wide entity graph or to only a portion of a system-wide graph. In some examples, entity graph 932 and/or knowledge graph 934 refers to a subset of a system-wide graph, where the subset pertains to a particular user or group of users of application system 930.

Knowledge graph 934 includes a graph-based representation of data stored in data storage system 960, described herein. Knowledge graph 934 represents relationships, also referred to as links or mappings, between entities or concepts as edges, or combinations of edges, between the nodes of the graph. In some examples, mappings between different pieces of data used by application system 930 or across multiple different application systems are represented by the knowledge graph 934.

In some examples, knowledge graph 934 is a subset or a superset of entity graph 932. In some examples, knowledge graph 934 includes multiple different entity graphs 932 that are joined by cross-application or cross-domain edges. In some examples, knowledge graph 934 joins entity graphs 932 that have been created across multiple different databases or across different software products. In some examples, the entity nodes of the knowledge graph 934 represent concepts, such as product surfaces, verticals, or application domains. In some examples, knowledge graph 934 includes a platform that extracts and stores different concepts that are used to establish links between data across multiple different software applications. Examples of concepts include topics, industries, and skills. In some examples, knowledge graph 934 is used to compute various types of relationship weights, affinity scores, similarity measurements, and/or statistical correlations between or among entities and/or concepts.

In the example of FIG. 9, application system 930 includes a user connection network 936. User connection network 936 includes, for instance, a social network service, professional social network system and/or other social graph-based applications. Content distribution service 938 includes, for example, a feed, chatbot or chat-style system, or a messaging system, such as a peer-to-peer messaging system that enables the creation and exchange of messages between users of application system 930 and the application system 930. Search engine 940 includes a search engine that enables users of application system 930 to input and execute search queries to retrieve information from one or more sources of information, such as user connection network 936, entity graph 932, knowledge graph 934, one or more data stores of data storage system 960, or one or more data resources and tools 950.

In the example of FIG. 9, application system 930 includes a content distribution service 938. The illustrative content distribution service 938 includes a data storage service, such as a web server, which stores digital content items, and transmits digital content items to users via user interface 912. In some examples, content distribution service 938 processes requests from, for example, application system 930 and/or sequence prediction system 980, and distributes digital content items to user systems 910 in response to requests.

A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, an input of a search query, or a page load. In some examples, content distribution service 938 is part of application system 930. In other examples, content distribution service 938 interfaces with application system 930 and/or sequence prediction system 980, for example, via one or more application programming interfaces (APIs).

In the example of FIG. 9, application system 930 includes a search engine 940. Search engine 940 includes a software system designed to search for and retrieve information by executing queries on one or more data stores, such as databases, connection networks, and/or graphs. The queries are designed to find information that matches specified criteria, such as keywords and phrases contained in user input and/or system-generated queries. For example, search engine 940 is used to retrieve data in response to user input and/or system-generated queries, by executing queries on various data stores of data storage system 960 and/or data resources and tools 950, or by traversing entity graph 932, knowledge graph 934.

Data resources and tools 950 include computing resources, such as data stores, databases, embedding-based retrieval mechanisms, code generators, etc., that are usable to operate a sequence prediction system. In some examples, data resources and tools 950 include computing resources that are internal to application system 930 or external to application system 930. Examples of data resources and tools 950 include entity graphs, knowledge graphs, indexes, databases, networks, applications, models (e.g., large language models and/or other artificial intelligence models or machine learning models), taxonomies, data services, web pages, vectors (e.g., data stores that store embeddings), and searchable digital catalogs. Each data resource or tool 950 enables a sequence prediction system to access the data resource or tool, for example by providing an application programming interface (API). In some examples, each data resource or tool 950 includes a monitoring service that periodically generates, publishes, or broadcasts availability and/or other performance metrics associated with the data resource. In some examples, a data resource or tool 950 provides a set of APIs that are used by a sequence prediction system to access the data resource or tool, obtain output from the data resource, and/or obtain performance metrics for the data resource or tool.

Data storage system 960 includes data stores and/or data services that store digital data received, used, manipulated, and produced by application system 930 and/or sequence prediction system 980, including contextual data, state data, prompts and/or prompt templates for generative artificial intelligence models or large language models, user inputs, system-generated outputs, metadata, attribute data, activity data. Examples of databases or data stores include vector databases, graph databases, relational databases, and key-value stores.

In the example of FIG. 9, data storage system 960 includes various data stores that store, for example, entity data, context data, prompts, embeddings, etc. In some examples, a data store includes a volatile memory such as a form of random access memory (RAM) and/or persistent memory. In some examples, the data storage system 960 is available on user system 910 or another device (e.g., one or more servers) for storing state data generated at the user system 910 or an application system 930. In some examples, a separate, personalized version of each or any data store is created for each user such that data is not shared between or among the separate, personalized versions of the data stores.

In some examples, data storage system 960 includes multiple different types of data storage and/or a distributed data service. In some examples, data service refers to a physical, geographic grouping of machines, a logical grouping of machines, or a single machine. In some examples, a data service includes a data center, a cluster, a group of clusters, or a machine. In some examples, data stores of data storage system 960 are configured to store data produced by real-time and/or offline (e.g., batch) data processing. In some examples, a data store configured for real-time data processing is referred to as a real-time data store. In some examples, a data store configured for offline or batch data processing is referred to as an offline data store. In some examples, data stores are implemented using databases, such as key-value stores, relational databases, and/or graph databases. In some examples, data is written to and read from data stores using query technologies, e.g., SQL or NoSQL.

Data storage system 960 resides on at least one persistent and/or volatile storage device. In some examples, data storage system 960 resides within the same local network as at least one other device of computing system 900 and/or in a network that is remote relative to at least one other device of computing system 900. Thus, although depicted as being included in computing system 900, portions of data storage system 960 are part of computing system 900 or accessed by computing system 900 over a network, such as network 920, in some examples.

Event logging service 970 captures and records activity data generated during operation of application system 930 and/or sequence prediction system 980, including user interface events generated at user systems 910 via user interface 912, in real time, and formulates the user interface events and/or other network activity data into a data stream that is consumed by, for example, a stream processing system. Examples of network activity data include logins, page loads, dialog inputs, input of search queries or query terms, selections of facets or filters, clicks on search results or graphical user interface control elements, scrolling lists of search results, and social action data such as likes, shares, comments, and social reactions (e.g., “insightful,” “curious,” “like,” etc.). For instance, in response to a user of application system 930 entering, via a user system 910, input or clicks on a user interface element, such as a workflow element, or a user interface control element such as a view, comment, share, or reaction button, or uploads a file, or inputs a query, or scrolls through a feed, etc., event logging service 970 fires an event to capture and store log data including an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web applications and mobile applications.

For instance, in response to a user entering input or reacting to system-generated output, such as a list of search results, event logging service 970 stores the corresponding event data in a log. Event logging service 970 generates a data stream that includes a record of real-time event data for each user interface event that has occurred. In some examples, event data logged by event logging service 970 is pre-processed and anonymized as needed so that it can be used as context data to configure machine learning models.

Sequence prediction system 980 includes any one or more of the components, features, models, or functions described herein with respect to a sequence prediction system, such as sequence prediction system 103 described with reference to FIG. 1, sequence prediction system 303 described with reference to FIG. 3, or the computing system described with reference to FIG. 7.

AI model service 990 includes one or more artificial intelligence-based models, such as large language models and/or other types of machine learning models including discriminative and/or generative models, neural networks, probabilistic models, statistical models, transformer-based models, and/or any combination of any of the foregoing. AI model service 990 enables sequence prediction systems to access to these models, for example by providing one or more application programming interfaces (APIs). In some examples, AI model service 990 includes a monitoring service that periodically generates, publishes, or broadcasts latency and/or other performance metrics associated with the models. In some examples, AI model service 990 provides a set of APIs that are usable by a sequence prediction system to obtain performance metrics for large language models and/or other machine learning models served by AI model service 990.

While not specifically shown, it should be understood that any of user system 910, application system 930, data resources and tools 950, data storage system 960, event logging service 970, sequence prediction system 980, and AI model service 990 includes an interface embodied as computer programming code stored in computer memory that when executed causes a computing device to enable bidirectional communication with any other of user system 910, application system 930, data resources and tools 950, data storage system 960, event logging service 970, sequence prediction system 980, and AI model service 990 using a communicative coupling mechanism. Examples of communicative coupling mechanisms include network interfaces, inter-process communication (IPC) interfaces and application program interfaces (APIs).

Each of user system 910, application system 930, data resources and tools 950, data storage system 960, event logging service 970, sequence prediction system 980, and AI model service 990 is implemented using at least one computing device that is communicatively coupled to electronic communications network 920. Any of user system 910, application system 930, data resources and tools 950, data storage system 960, event logging service 970, sequence prediction system 980, and AI model service 990 are bidirectionally communicatively coupled by network 920, in some examples. User system 910 as well as other different user systems (not shown) are bidirectionally communicatively coupled to application system 930 and/or sequence prediction system 980, in some examples.

In some examples, a typical user of user system 910 is an administrator or end user of application system 930 or sequence prediction system 980. User system 910 is configured to communicate bidirectionally with any of application system 930, data resources and tools 950, data storage system 960, event logging service 970, sequence prediction system 980, and AI model service 990 over network 920.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

Examples of the features and functionality of user system 910, application system 930, data resources and tools 950, data storage system 960, event logging service 970, sequence prediction system 980, and AI model service 990 are implemented using computer software, hardware, or software and hardware, which include combinations of automated functionality, data structures, and digital data that are represented schematically in the figures. User system 910, application system 930, data resources and tools 950, data storage system 960, event logging service 970, sequence prediction system 980, and AI model service 990 are shown as separate elements in FIG. 9 for ease of discussion but, except as otherwise described, the illustration is not meant to imply that separation of these elements is required. In some examples, the systems, services, and data stores (or their functionality) of each of user system 910, application system 930, data resources and tools 950, data storage system 960, event logging service 970, sequence prediction system 980, and AI model service 990 are divided over any number of physical systems, including a single physical computer system, and communicate with each other in any appropriate manner.

In the example of FIG. 10, portions of sequence prediction system 980 that are implemented on a front end system, such as a user's device or other physical device, and a back end system, such as one or more servers, in some examples, are collectively represented as sequence prediction system 1050. Portions of sequence prediction system 980 are not required to be implemented all on the same computing device, in the same memory, or loaded into the same memory at the same time. In some examples, access to portions of sequence prediction system 980 is limited to different, mutually exclusive sets of user systems and/or servers. In some examples, a separate, personalized version of sequence prediction system 980 is created for each user of the sequence prediction system 980 such that data is not shared between or among the separate, personalized versions of the sequence prediction system 980. In some examples, certain portions of sequence prediction system 980 are implemented on user systems while other portions of sequence prediction system 980 are implemented on a server computer or group of servers. In some examples, one or more portions of sequence prediction system 980 are implemented on user systems. For example, sequence prediction system 980 is entirely implemented on user systems, e.g., client devices, in some examples. In some examples, a version of sequence prediction system 980 is embedded in a client device's operating system or stored at the client device and loaded into memory at execution time.

The examples shown in FIG. 9 and the accompanying description, above are provided for illustration purposes. This disclosure is not limited to the described examples.

FIG. 10 is a block diagram of an example computer system including components of a sequence prediction system in accordance with some examples of the present disclosure.

In FIG. 10, an example machine of a computer system 1000 is shown, within which a set of instructions for causing the machine to perform any of the aspects described are executed. In some examples, the computer system 1000 corresponds to a component of a networked computer system (e.g., any one or more of the components shown in FIG. 1, FIG. 2, FIG. 3, FIG. 5, FIG. 6, FIG. 7, FIG. 9) that includes, is coupled to, or utilizes a machine to execute an operating system to perform operations corresponding to any one or more components shown in FIG. 1, FIG. 2, FIG. 3, FIG. 5, FIG. 6, FIG. 7, FIG. 9. For example, computer system 1000 corresponds to a portion of a computing system when the computing system is executing a portion of any one or more components shown in FIG. 1, FIG. 2, FIG. 3, FIG. 5, FIG. 6, FIG. 7, FIG. 9.

In some examples, the machine is connected (e.g., networked) to other machines in a network, such as a local area network (LAN), an intranet, an extranet, and/or the Internet. In some examples, the machine operates in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM) or Rambus DRAM (RDRAM), etc.), a memory 1003 (e.g., flash memory, static random access memory (SRAM), etc.), an input/output system 1010, and a data storage system 1040, which communicate with each other via a bus 1030.

Processing device 1002 represents at least one general-purpose processing device such as a microprocessor, a central processing unit, or the like. In some examples, the processing device includes a complex instruction set computing (CISC) microprocessor, reduced instruction set computing (RISC) microprocessor, very long instruction word (VLIW) microprocessor, or a processor implementing other instruction sets, or processors implementing a combination of instruction sets. In some examples, processing device 1002 includes at least one special-purpose processing device such as an application specific integrated circuit (ASIC), a field programmable gate array (FPGA), a digital signal processor (DSP), network processor, or the like. The processing device 1002 is configured to execute instructions 1012 for performing the operations and steps discussed herein.

In some examples of FIG. 10, sequence prediction system 1050 represents portions of sequence prediction system 980 while the computer system 1000 is executing those portions of sequence prediction system 980. Instructions 1012 include portions of sequence prediction system 1050 when those portions of the sequence prediction system 1050 are being executed by processing device 1002. Thus, the sequence prediction system 1050 is shown in dashed lines as part of instructions 1012 to illustrate that, at times, portions of the sequence prediction system 1050 are executed by processing device 1002. In some examples, when at least some portion of the sequence prediction system 1050 is embodied in instructions to cause processing device 1002 to perform the methods described herein, some of those instructions are read into processing device 1002 (e.g., into an internal cache or other memory) from main memory 1004 and/or data storage system 1040. However, it is not required that all of the sequence prediction system 1050 be included in instructions 1012 at the same time and portions of the sequence prediction system 1050 are stored in at least one other component of computer system 1000 at other times, e.g., when at least one portion of the sequence prediction system 1050 are not being executed by processing device 1002.

The computer system 1000 further includes a network interface device 1008 to communicate over the network 1020. Network interface device 1008 provides a two-way data communication coupling to a network. In some examples, network interface device 1008 includes an integrated-services digital network (ISDN) card, cable modem, satellite modem, or a modem to provide a data communication connection to a corresponding type of telephone line. In some examples, network interface device 1008 includes a local area network (LAN) card to provide a data communication connection to a compatible LAN. In some examples, wireless links are implemented. In some examples, network interface device 1008 sends and receives electrical, electromagnetic, or optical signals that carry digital data streams representing various types of information.

In some examples, the network link provides data communication through at least one network to other data devices. In some examples, a network link provides a connection to the world-wide packet data communication network commonly referred to as the “Internet,” e.g., through a local network to a host computer or to data equipment operated by an Internet Service Provider (ISP). Local networks and the Internet use electrical, electromagnetic, or optical signals that carry digital data to and from computer system 1000.

Computer system 1000 is capable of sending messages and receiving data, including program code, through the network(s) and network interface device 1008. In some examples, a server transmits a requested code for an application program through the Internet and network interface device 1008. In some examples, the received code is executed by processing device 1002 as it is received, and/or stored in data storage system 1040 or other non-volatile storage for later execution.

The input/output system 1010 includes an output device, such as a display, for example a liquid crystal display (LCD) or a touchscreen display, for displaying information to a computer user, or a speaker, a haptic device, or another form of output device. In some examples, the input/output system 1010 includes an input device such as alphanumeric keys and other keys configured for communicating information and command selections to processing device 1002. Alternatively or in addition, an input device includes a cursor control, such as a mouse, a trackball, or cursor direction keys for communicating direction information and command selections to processing device 1002 and for controlling cursor movement on a display. Alternatively or in addition, an input device includes a microphone, a sensor, or an array of sensors to communicate sensed information to processing device 1002. Sensed information includes, for example, voice commands, audio signals, geographic location information, haptic information, and/or digital imagery.

The data storage system 1040 includes a machine-readable storage medium 1042 (also known as a computer-readable medium) on which is stored at least one set of instructions 1044 or software embodying any of the methodologies or functions described herein. In some examples, instructions 1044 reside, completely or at least partially, within the main memory 1004 and/or within the processing device 1002 during execution thereof by the computer system 1000, the main memory 1004 and the processing device 1002 also constituting machine-readable storage media. In some examples, the instructions 1044 include instructions to implement functionality corresponding to a sequence prediction system (e.g., any one or more of the components shown in FIG. 1, FIG. 2, FIG. 3, FIG. 5, FIG. 6, FIG. 7, FIG. 9).

Dashed lines are used in FIG. 10 to indicate that it is not required that the sequence prediction system be embodied entirely in instructions 1012, 1014, and 1044 at the same time. In one example, portions of the sequence prediction system are embodied in instructions 1014, which are read into main memory 1004 as instructions 1014, and portions of instructions 1012 are read into processing device 1002 as instructions 1012 for execution. In another example, some portions of the sequence prediction system are embodied in instructions 1044 while other portions are embodied in instructions 1014 and still other portions are embodied in instructions 1012.

While the machine-readable storage medium 1042 is shown in an example to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media.

The examples shown in FIG. 10 and the accompanying description, above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure refers to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also or alternatively relates to an apparatus for performing the operations described. In some examples, the apparatus is specially constructed or includes a general-purpose computer selectively activated or reconfigured by a computer program stored in the computer. In some examples, a computer system or other data processing system, including any one or more of the components shown in FIG. 1, FIG. 2, FIG. 3, FIG. 5, FIG. 6, FIG. 7, FIG. 9, FIG. 10, carries out the above-described computer-implemented methods in response to a processor executing a computer program (e.g., a sequence of instructions) contained in a memory or other non-transitory machine-readable storage medium. In some examples, the computer program is stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions and which is couplable to a computer or computer bus.

The algorithms and displays presented herein are not inherently related to any particular computer. In addition, the present disclosure is not described with reference to any particular programming language. A variety of programming languages are usable to implement aspects of this disclosure.

In some examples, aspects of this disclosure are provided as a computer program product, or software, which includes a machine-readable medium having instructions stored thereon, where the instructions are used to program a computer system (or other electronic devices) to perform processes as described. A machine-readable medium includes any mechanism for storing information in a form readable by a machine (e.g., a computer). In some examples, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In some examples, techniques described are implemented with privacy safeguards to protect user privacy. In some examples, the techniques described are implemented with user privacy safeguards to prevent unauthorized access to personal data and confidential data. The training of the AI models described herein is executed to benefit all users fairly, without causing or amplifying unfair bias.

According to some examples, the techniques for the models described herein do not make inferences or predictions about individuals unless requested to do so through an input. According to some examples, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities.

According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some examples, users may provide feedback while using the techniques described herein, which may be used to improve or modify the platform and products. In some examples, any personal data associated with a user, such as personal information provided by the user to the platform, may be deleted from storage upon user request. In some examples, personal information associated with a user may be permanently deleted from storage when a user deletes their account from the platform.

According to the techniques described herein, personal data may be removed from any training dataset that is used to train AI models. The techniques described herein may utilize tools for anonymizing user and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some examples, tools are used with the techniques described herein to identify and mitigate risks associated with AI in all products and AI systems. In some examples, notices may be provided to users when AI tools are being used to provide features.

Illustrative examples of the technologies disclosed herein are provided below. An example of the technologies may include any of the examples described herein, or any combination of any of the examples described herein, or any combination of any portions of the examples described herein.

In some aspects, the techniques described herein relate to a method including: formulating a training input for a neural network model with attention to include action data and descriptive content, wherein the action data includes a first entity identifier (ID) and a first sequence of actions associated with the first entity ID, and the descriptive content describes a first entity associated with the first entity ID, wherein an action in the first sequence of actions includes an electronic transmission involving the first entity and a second entity; and using the training input and a non-standardized tokenizer to train the neural network model with attention to generate and output a second sequence of actions. In some examples, recommended actions such as actions included in a second sequence of actions, include actions a user is likely to take and/or actions that the user likely would not have thought to take otherwise.

In some aspects, the techniques described herein relate to a method, wherein formulating the training input includes determining that the action data includes a reserved word and using the non-standardized tokenizer to convert the reserved word to a token that describes the reserved word in the first sequence of actions, wherein the non-standardized tokenizer uses a second vocabulary to determine and output a word-based token for the reserved word.

In some aspects, the techniques described herein relate to a method, wherein formulating the training input includes using the non-standardized tokenizer to determine and output a word-based token for the first entity identifier.

In some aspects, the techniques described herein relate to a method, wherein formulating the training input includes using a standardized tokenizer to convert the descriptive content to tokens that describe the first entity, wherein the standardized tokenizer uses a first vocabulary different from the second vocabulary to determine and output sub word-based tokens for the descriptive content.

In some aspects, the techniques described herein relate to a method, wherein formulating the training input includes including word-based tokens for actions in the first sequence of actions, the word-based token for the first entity ID, and the sub word-based tokens for the descriptive content in the training input.

In some aspects, the techniques described herein relate to a method, wherein the action data includes a natural language or textual representation of a graph, and the method further includes generating a natural language or textual representation of the graph.

In some aspects, the techniques described herein relate to a method, wherein the action data includes a natural language or textual representation of a data set and the method further includes generating the natural language or textual representation of the data set.

In some aspects, the techniques described herein relate to a method, wherein an action in the action data includes a natural language or textual representation of an application programming interface (API) call and the method further includes generating the natural language or textual representation of the API call.

In some aspects, the techniques described herein relate to a method, wherein an action in the action data includes a spatial position related to a length of the action data and a temporal position related to a time of occurrence of the action, and the method further includes generating a representation of the action that excludes the spatial position.

In some aspects, the techniques described herein relate to a method, further including: logging the first sequence of actions during a session including a user operating an application; receiving, from the first entity, a response to the second sequence of actions; and supplementing the first sequence of actions by executing the second sequence of actions.

In some aspects, the techniques described herein relate to a method, wherein the first sequence of actions includes a query and the second sequence of actions is generated and output by the neural network model with attention in response to the query and the first sequence of actions.

In some aspects, the techniques described herein relate to a method, wherein the query includes a second entity ID associated with a second entity, and the second sequence of actions is generated and output by the neural network model with attention using the first entity ID and the second entity ID.

In some aspects, the techniques described herein relate to a method, wherein the query includes a request for a summary of actions of the first entity, and the second sequence of actions generated and output by the neural network model includes the summary of actions of the first entity.

In some aspects, the techniques described herein relate to a method, wherein the query includes the first entity ID and a second entity ID, and the second sequence of actions generated and output by the neural network model includes an action on an entity associated with the second entity ID.

In some aspects, the techniques described herein relate to a method, wherein the query includes a first list of entity IDs and the second sequence of actions generated and output by the neural network model with attention includes a second list of entity IDs.

In some aspects, the techniques described herein relate to a system including: a processor; and memory coupled to the processor, wherein the memory includes instructions that when executed by the processor cause the processor to: formulate a training input for a neural network model with attention to include action data and descriptive content, wherein the action data includes a first entity identifier (ID) and a first sequence of actions associated with the first entity ID, and the descriptive content describes a first entity associated with the first entity ID, wherein an action in the first sequence of actions includes an electronic transmission involving the first entity and a second entity; and use the training input, including the first entity ID, and a non-standardized tokenizer, to train the neural network model with attention to generate and output a second sequence of actions.

In some aspects, the techniques described herein relate to a system, wherein the instructions further cause the processor to: determine that the action data includes a reserved word; use the non-standardized tokenizer and a second vocabulary to convert the reserved word to a word-based token that describes the reserved word in the first sequence of actions; use the non-standardized tokenizer to determine and output a word-based token for the first entity identifier; use a standardized tokenizer to convert the descriptive content to tokens that describe the first entity, wherein the standardized tokenizer uses a first vocabulary different from the second vocabulary to determine and output sub word-based tokens for the descriptive content; and include the word-based token for the reserved word, the word-based token for the first entity ID, and the sub word-based tokens for the descriptive content, in the training input.

In some aspects, the techniques described herein relate to a system, wherein the instructions further cause the processor to: log the first sequence of actions during a session including a user operating an application; receive, from the first entity, a response to the second sequence of actions; and supplement the first sequence of actions by executing the second sequence of actions.

In some aspects, the techniques described herein relate to a non-transitory computer readable medium including instructions that when executed by a processor cause the processor to: formulate a training input for a neural network model with attention to include action data and descriptive content, wherein the action data includes a first entity identifier (ID) and a first sequence of actions associated with the first entity ID, and the descriptive content describes a first entity associated with the first entity ID, wherein an action in the first sequence of actions includes an electronic transmission involving the first entity and a second entity; and use the training input, including the first entity ID, and a non-standardized tokenizer, to train the neural network model with attention to generate and output a second sequence of actions.

In some aspects, the techniques described herein relate to a non-transitory computer readable medium, wherein the instructions further cause the processor to: determine that the action data includes a reserved word; use the non-standardized tokenizer and a second vocabulary to convert the reserved word to a word-based token that describes the reserved word in the first sequence of actions; use the non-standardized tokenizer to determine and output a word-based token for the first entity identifier; use a standardized tokenizer to convert the descriptive content to tokens that describe the first entity, wherein the standardized tokenizer uses a first vocabulary different from the second vocabulary to determine and output sub word-based tokens for the descriptive content; and include the word-based token for the reserved word, the word-based token for the first entity ID, and the sub word-based tokens for the descriptive content, in the training input.

Clause 1. A computer-implemented method comprising:
formulating a training input for a neural network model (132) with attention to comprise action data (106) and descriptive content (104), wherein the action data (106) comprises a first entity identifier (ID) and a first sequence of actions logged via use of a computing device by a first entity and the descriptive content (104) describes the first entity, wherein an action in the first sequence of actions comprises an electronic transmission involving the first entity and a second entity; and
using the training input, including the first entity ID, and a non-standardized tokenizer, to train the neural network model (132) with attention to generate and output a second sequence of actions, wherein a response to the second sequence of actions by the first entity via the computing device is to supplement the first sequence of actions.

Clause 2. The method of clause 1, comprising:
logging the first sequence of actions during a session whereby the first entity is a user operating an application;
receiving, from the first entity, the response to the second sequence of actions; and
supplementing the first sequence of actions by executing the second sequence of actions to operate the application.

Clause 3. The method of any preceding clause, comprising assessing the second sequence of actions with one or more rules, and where an output of the assessment indicates a potentially malicious sequence of actions, isolating an account of the first entity or preventing the actions from being executed.

Clause 4. The method of any preceding clause, wherein formulating the training input comprises using a standardized tokenizer to convert the action data to tokens that describe actions in the first sequence of actions, wherein the standardized tokenizer outputs word-based tokens for the actions.

Clause 5. The method of clause 4, wherein the action data comprises a first entity identifier (ID) and formulating the training input comprises using the standardized tokenizer to output a word-based token for the first entity identifier.

Clause 6. The method of clause 5, wherein formulating the training input comprises using the non-standardized tokenizer to convert the descriptive content to tokens that describe the first entity, wherein the non-standardized tokenizer outputs sub word-based tokens for the descriptive content.

Clause 7. The method of clause 6, wherein formulating the training input comprises including the word-based tokens for the actions, the word-based token for the first entity ID, and the sub word-based tokens for the descriptive content in the training input.

Clause 8. The method of any of clauses 1 to 4, wherein the action data comprises a natural language or textual representation of a graph, and the method further comprises generating a natural language or textual representation of the graph.

Clause 9. The method of any of clauses 1 to 4, wherein the action data comprises a natural language or textual representation of a data set and the method further comprises generating the natural language or textual representation of the data set.

Clause 10. The method of any of clauses 1 to 4, wherein an action in the action data comprises a natural language or textual representation of an application programming interface (API) call and the method further comprises generating the natural language or textual representation of the API call.

Clause 11. The method of any of clauses 1 to 4, wherein an action in the action data comprises a spatial position related to a length of the action data and a temporal position related to a time of occurrence of the action, and the method further comprises generating a representation of the action that excludes the spatial position.

Clause 12. The method of any preceding clause, wherein an action is an instruction to control any of: a physical device, a robot, a vehicle, a communications network node.

Clause 13. A computer-implemented method comprising:
logging a first sequence of actions (106) during first use of a software application by a first entity, wherein an action in the first sequence of actions comprises an electronic transmission and a second entity; and
providing a second sequence of actions to the software application for selection by the first entity, wherein the second sequence of actions is to supplement the first sequence of actions (106), the second sequence of actions is generated and output by a neural network model (132) with attention in response to the first sequence of actions and a first entity identifier (ID) associated with the first entity, and descriptive content (104) associated with the first entity ID, the neural network model (132) with attention is trained using a training instance comprising the first entity ID, a sequence of tokens that describes actions during second use of the software application by the first entity, and a token that describes the first entity.

Clause 14. The method of clause 13, wherein the first sequence of actions comprises a query and the second sequence of actions is generated and output by the neural network model with attention in response to the query and the first sequence of actions.

Clause 15. The method of clause 14, wherein the query comprises a second entity ID associated with a second entity, and the second sequence of actions is generated and output by the neural network model with attention using the first entity ID and the second entity ID.

Clause 16. The method of clause 14, wherein the query comprises a request for a summary of actions of the first entity, and the second sequence of actions generated and output by the neural network model comprises the summary of actions of the first entity.

Clause 17. The method of clause 14, wherein the query comprises the first entity ID and a second entity ID, and the second sequence of actions generated and output by the neural network model comprises an action on an entity associated with the second entity ID.

Clause 18. The method of clause 14, wherein the query comprises a first list of entity IDs and the second sequence of actions generated and output by the neural network model with attention comprises a second list of entity IDs.

Clause 19. The method of any of clauses 13 to 18, comprising: in response to receiving input selecting the second sequence of actions, triggering execution of the second sequence of actions so as to operate the software application.

Clause 20. The method of any of clauses 13 to 19, comprising: assessing the second sequence of actions with one or more rules, and where an output of the assessment indicates a malicious sequence of actions, isolating an account of the first entity or preventing the actions from being executed.

Clause 21. A system comprising a process and memory comprising instructions that when executed by the processor cause the processor to perform any of the preceding clauses.

Clause 22. A non-transitory computer-readable medium comprising instructions that when executed by a processor cause the processor to perform any of the preceding clauses.

Examples of the disclosure have been described. The described examples are modifiable without departing from the broader spirit and scope of the disclosure as set forth in the claims. The specification and drawings are to be regarded in an illustrative sense rather than a restrictive sense.

What is claimed is:

1. A method comprising:
formulating a training input for a neural network model with attention to comprise action data and descriptive content, wherein the action data comprises a first entity identifier (ID) and a first sequence of actions associated with the first entity ID, and the descriptive content describes a first entity associated with the first entity ID, wherein an action in the first sequence of actions comprises an electronic transmission involving the first entity and a second entity; and
using the training input, including the first entity ID, and a non-standardized tokenizer, to train the neural network model with attention to generate and output a second sequence of actions.

2. The method of claim 1, wherein formulating the training input comprises determining that the action data comprises a reserved word and using the non-standardized tokenizer to convert the reserved word to a token that describes the reserved word in the first sequence of actions, wherein the non-standardized tokenizer uses a non-standardized vocabulary to determine and output a word-based token for the reserved word.

3. The method of claim 2, wherein formulating the training input comprises using the non-standardized tokenizer to determine and output a word-based token for the first entity identifier.

4. The method of claim 3, wherein formulating the training input comprises using a standardized tokenizer to convert the descriptive content to tokens that describe the first entity, wherein the standardized tokenizer uses a first vocabulary different from the non-standardized vocabulary to determine and output sub word-based tokens for the descriptive content.

5. The method of claim 4, wherein formulating the training input comprises including word-based tokens for actions in the first sequence of actions, the word-based token for the first entity ID, and the sub word-based tokens for the descriptive content in the training input.

6. The method of claim 1, wherein the action data comprises a natural language textual representation of a graph, and the method further comprises generating a natural language textual representation of the graph.

7. The method of claim 1, wherein the action data comprises a natural language textual representation of a data set and the method further comprises generating the natural language textual representation of the data set.

8. The method of claim 1, wherein an action in the action data comprises a natural language textual representation of an application programming interface (API) call and the method further comprises generating the natural language textual representation of the API call.

9. The method of claim 1, wherein an action in the action data comprises a spatial position related to a length of the action data and a temporal position related to a time of occurrence of the action, and the method further comprises generating a representation of the action that excludes the spatial position.

10. The method of claim 1, further comprising:
logging the first sequence of actions during a session comprising a user operating an application;
receiving, from the first entity, a response to the second sequence of actions; and
supplementing the first sequence of actions by executing the second sequence of actions.

11. The method of claim 10, wherein the first sequence of actions comprises a query and the second sequence of actions is generated and output by the neural network model with attention in response to the query and the first sequence of actions.

12. The method of claim 11, wherein the query comprises a second entity ID associated with a second entity, and the second sequence of actions is generated and output by the neural network model with attention using the first entity ID and the second entity ID.

13. The method of claim 11, wherein the query comprises a request for a summary of actions of the first entity, and the second sequence of actions generated and output by the neural network model comprises the summary of actions of the first entity.

14. The method of claim 11, wherein the query comprises the first entity ID and a second entity ID, and the second sequence of actions generated and output by the neural network model comprises an action on an entity associated with the second entity ID.

15. The method of claim 11, wherein the query comprises a first list of entity IDs and the second sequence of actions generated and output by the neural network model with attention comprises a second list of entity IDs.

16. A system comprising:
a processor; and
memory coupled to the processor, wherein the memory comprises instructions that when executed by the processor cause the processor to:
formulate a training input for a neural network model with attention to comprise action data and descriptive content, wherein the action data comprises a first entity identifier (ID) and a first sequence of actions associated with the first entity ID, and the descriptive content describes a first entity associated with the first entity ID, wherein an action in the first sequence of actions comprises an electronic transmission involving the first entity and a second entity; and
use the training input, including the first entity ID, and a non-standardized tokenizer, to train the neural network model with attention to generate and output a second sequence of actions.

17. The system of claim 16, wherein the instructions further cause the processor to:
determine that the action data comprises a reserved word;
use the non-standardized tokenizer and a second vocabulary to convert the reserved word to a word-based token that describes the reserved word in the first sequence of actions;
use the non-standardized tokenizer to determine and output a word-based token for the first entity identifier;
use a standardized tokenizer to convert the descriptive content to tokens that describe the first entity, wherein the standardized tokenizer uses a first vocabulary different from the second vocabulary to determine and output sub word-based tokens for the descriptive content; and
include the word-based token for the reserved word, the word-based token for the first entity ID, and the sub word-based tokens for the descriptive content, in the training input.

18. The system of claim 16, wherein the instructions further cause the processor to:
log the first sequence of actions during a session comprising a user operating an application;
receive, from the first entity, a response to the second sequence of actions; and
supplement the first sequence of actions by executing the second sequence of actions.

19. A non-transitory computer readable medium comprising instructions that when executed by a processor cause the processor to:
formulate a training input for a neural network model with attention to comprise action data and descriptive content, wherein the action data comprises a first entity identifier (ID) and a first sequence of actions associated with the first entity ID, and the descriptive content describes a first entity associated with the first entity ID, wherein an action in the first sequence of actions comprises an electronic transmission involving the first entity and a second entity; and
use the training input, including the first entity ID, and a non-standardized tokenizer, to train the neural network model with attention to generate and output a second sequence of actions.

20. The non-transitory computer readable medium of claim 19, wherein the instructions further cause the processor to:
determine that the action data comprises a reserved word;
use the non-standardized tokenizer and a second vocabulary to convert the reserved word to a word-based token that describes the reserved word in the first sequence of actions;
use the non-standardized tokenizer to determine and output a word-based token for the first entity identifier;
use a standardized tokenizer to convert the descriptive content to tokens that describe the first entity, wherein the standardized tokenizer uses a first vocabulary different from the second vocabulary to determine and output sub word-based tokens for the descriptive content; and
include the word-based token for the reserved word, the word-based token for the first entity ID, and the sub word-based tokens for the descriptive content, in the training input.
